(19) United States
(12) Patent Application Publication
(10) Pub. No.: US 2012/0005021 A1
(43) Pub. Date: Jan. 5, 2012

(54) SELECTING ADVERTISEMENTS USING USER SEARCH HISTORY SEGMENTATION

(75) Inventor: Rajiv Ratnam, Los Gatos, CA (US)

(73) Assignee: YAHOO! INC., Sunnyvale, CA (US)

(21) Appl. No.: 12/829,954

(22) Filed: Jul. 2, 2010

(51) Int. Cl. G06Q 99/00; G06F 17/30

(52) U.S. Cl. 705/14.54; 707/737; 707/E17.014; 707/769; 707/E17.089; 707/748; 707/749

(57) ABSTRACT

Techniques are described herein for selecting an advertisement using user search history segmentation. Instances of queries that are provided by a user are referred to collectively as the search history of the user. The search history is segmented into sessions that correspond to respective tasks of the user. Each of the sessions includes a respective subset of the query instances that are included in the user's search history. A weight is assigned to each session based on attribute(s) of the respective session. A session that includes a first subset of the query instances is selected based on the weight that is assigned to that session. Features are extracted from query instances that are included in the first subset. Weights are assigned to the extracted features based on attribute(s) of the first subset. An advertisement is selected to be provided to the user based on the extracted features and corresponding weights.

### BACKGROUND OF THE INVENTION

1. Field of the Invention

The present invention relates to online advertising.

2. Background

Certain advertisement (“ad”) networks enable ads (e.g., contextual ads, display ads) to be served to users who visit the Web sites of publishers that are participating in the ad network. Advertisers generate the ads and buy placements (a.k.a. inventory) for those ads on the publishers' Web sites usually based on the anticipated audiences for those sites and/or the content of those sites. These ads may be graphical (“display ads”) or textual. A placement represents a publisher's agreement to serve a trafficked (i.e., specified) ad to users when the users visit the publisher's site. The publisher often serves the trafficked display or contextual ad contemporaneously with other content associated with the publisher's site. Similarly, sponsored search advertising systems serve ads (“sponsored ads”) to users that enter queries on search engine websites, often alongside the responses to the queries.

Ad networks typically include ad serving systems that determine which advertisements are to be provided to users. In conventional contextual or display ad networks, when a publisher receives a page view from a user, the publisher sends an ad call to an ad serving system. An ad call is a request for an advertisement. The ad serving system selects an advertisement from an ad inventory based on various factors. The query that is used by the ad serving system to select the advertisement depends on the configuration of the ad serving system. For example, the ad serving system may be configured to select the advertisement based on the user's most recent query. The advertisement traditionally is selected based on a single query of the user. The ad serving system then sends the advertisement to the publisher, so that the publisher can serve the advertisement to the user. Sponsored search advertising systems work similarly. When the search engine receives a query from the user, an ad call is sent to the ad serving system, which typically selects an advertisement based on that query.

In both cases, however, selecting an advertisement based on a single query of a user may result in selection of a marginally relevant (or irrelevant) advertisement. For example, the search query may include uncommon terminology (e.g., a product model number) that may result in few matches from the ad inventory. In another example, the query may be navigational in nature, meaning that the query is provided by the user in an effort to navigate to a particular Web destination. In yet another example, the query may be inherently ambiguous and difficult to accurately match advertisements against. Moreover, search engine users typically use multiple queries that are spread over time to obtain information that they are seeking.

### BRIEF SUMMARY OF THE INVENTION

Various approaches are described herein for, among other things, selecting an advertisement using user search history segmentation. Instances of queries that are provided by a user are referred to collectively as the search history of the user. Each query instance may correspond to any of a variety of tasks of the user. Examples of a task include but are not limited to buying car insurance, scheduling a trip, researching a breed of dog, etc. A task may have any suitable scope. For instance, the aforementioned task of scheduling a trip may be parsed into multiple tasks, such as scheduling an airline flight, booking a hotel, scheduling tours in the locality of the destination, and so on.

An example method of selecting an advertisement using user search history segmentation is described. In accordance with this example method, a search history of a user is segmented into sessions that correspond to respective tasks of the user. The search history includes query instances. Each session includes a respective subset of the query instances. Weights are assigned to the respective sessions. Each weight is based on at least one attribute of the subset that is included in the respective session to which the weight is assigned. A session that includes a first subset of the query instances is selected based on a weight that is assigned to that session. Features are extracted from query instances that are included in the first subset. Weights are assigned to the respective extracted features based on attribute(s) of the session that includes the first subset. An advertisement is selected to be provided to the user based on the extracted features and the weights that are assigned to the extracted features.

An example system is described that includes a segmentation module, an assignment module, a session selection module, a feature extraction module, and an ad selection module. The segmentation module is configured to segment a search history of a user into sessions that correspond to respective tasks of the user. The search history includes query instances. Each session includes a respective subset of the query instances. The assignment module is configured to assign weights to the respective sessions. Each weight is based on at least one attribute of the subset that is included in the respective session to which the weight is assigned. The session selection module is configured to select a session that includes a first subset of the query instances based on a weight that is assigned to that session. The feature extraction module is configured to extract features from query instances that are included in the first subset. The assignment module is further configured to assign weights to the respective extracted features based on attribute(s) of the session that includes the first subset. The ad selection module is configured to select an advertisement to be provided to the user based on the extracted features and the weights that are assigned to the extracted features.

An example computer program product is described that includes a computer-readable medium having computer program logic recorded thereon for enabling a processor-based system to select an advertisement using user search history segmentation. The computer program logic includes first, second, third, fourth, fifth, and sixth program logic modules. The first program logic module is for enabling the processor-based system to segment a search history of a user into sessions that correspond to respective tasks of the user. The search history includes query instances. Each session includes a respective subset of the query instances. The second program logic module is for enabling the processor-based system to assign weights to the respective sessions. Each weight is based on at least one attribute of the subset that is included in the respective session to which the weight is assigned. The third program logic module is for enabling the processor-based system to select a session that includes a first subset of the query instances based on a weight that is assigned to that session. The fourth program logic module is for enabling the processor-based system to extract features from query instances that are included in the first subset. The fifth program logic module is for enabling the processor-based system to assign weights to the respective extracted features based on attribute(s) of the session that includes the first subset. The sixth program logic module is for enabling the processor-based system to select an advertisement to be provided to the user based on the extracted features and the weights that are assigned to the extracted features.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example advertisement (“ad”) network in accordance with an embodiment described herein.

FIGS. 2, 3A, 3B, 5, 7, 9, 10, 12A-12B, and 13 depict flowcharts of example methods for selecting an advertisement using user search history segmentation in accordance with embodiments described herein.

FIGS. 4, 8, and 14 are block diagrams of example implementations of an ad selector shown in FIG. 1 in accordance with embodiments described herein.

FIGS. 6 and 11 are block diagrams of example implementations of segmentation modules shown in FIGS. 4 and 8 in accordance with embodiments described herein.

FIG. 15 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. INTRODUCTION

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of selecting an advertisement using user search history segmentation. Instances of queries that are provided by a user are referred to collectively as the search history of the user. Each query instance may correspond to any of a variety of tasks of the user. Examples of a task include but are not limited to buying car insurance, scheduling a trip, researching a breed of dog, etc. A task may have any suitable scope. For instance, the aforementioned task of scheduling a trip may be parsed into multiple tasks, such as scheduling an airline flight, booking a hotel, scheduling tours in the locality of the destination, and so on. The search history is segmented into sessions that correspond to respective tasks of the user. Each of the sessions includes a respective subset of the query instances. A weight is assigned to each session based on attribute(s) of the respective session. A session that includes a first subset of the query instances is selected based on the weight that is assigned to that session. Features are extracted from query instances that are included in the first subset. An advertisement is selected to be provided to the user based on the extracted features.

Techniques described herein have a variety of benefits as compared to conventional techniques for selecting an advertisement to be provided to a user. For example, by selecting an advertisement using user search history segmentation, intent of a user may be more efficiently and/or more accurately disambiguated. Techniques described herein may use query features that are associated with a common user task to target advertisements to a user. The techniques may use query features that are more monetizable than the user's most recent query. Query features may be based exclusively on queries that are provided by the user to whom advertisement(s) are to be targeted. Queries and/or user tasks for which a conversion has occurred may be removed from consideration for purposes of ad targeting. Similarly, queries and/or user tasks with respect to which clicks have occurred may be favored with relatively higher weights. In the domain of contextual advertising, features that are extracted from user tasks that are related to a page (e.g., a Web page) may be used to determine which elements of the page are likely to be of interest to the user (and potentially more important for advertisement matching).

### II. EXAMPLE EMBODIMENTS

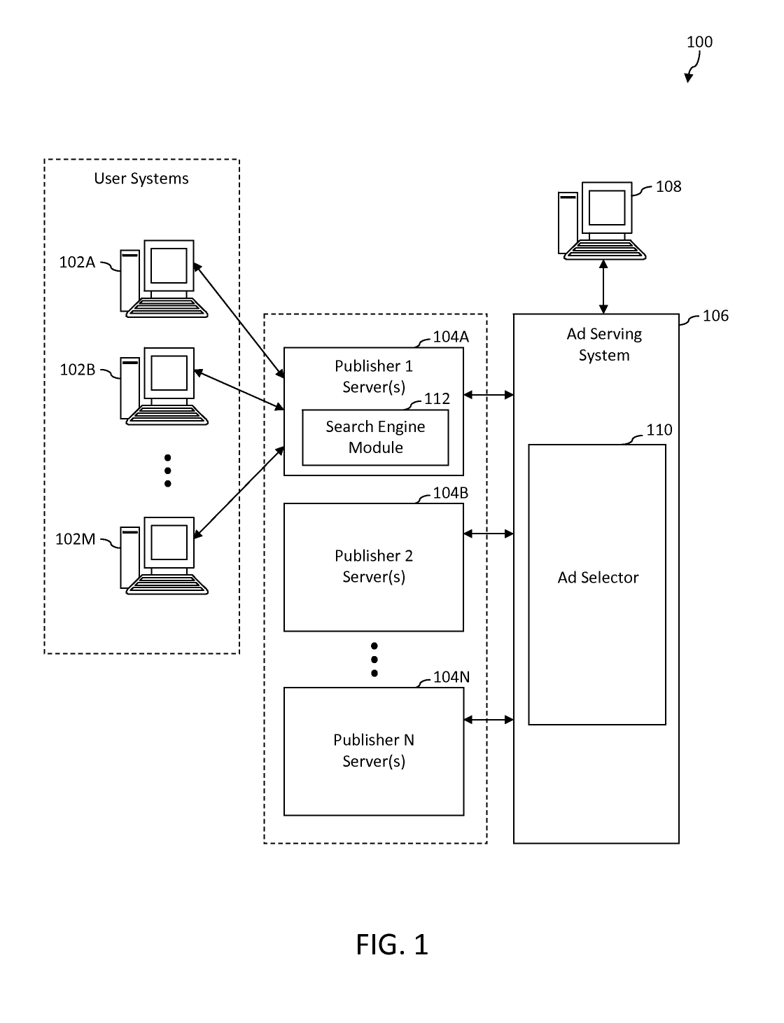

FIG. 1 is a block diagram of an example advertisement (“ad”) network in accordance with an embodiment of the present invention. Generally speaking, ad network 100 operates to serve ads (e.g., contextual ads, sponsored ads, display ads, etc.) provided by advertisers to sites (e.g., Web sites) published by publishers when such sites are accessed by certain users of the network, thereby delivering the ads to the users. As shown in FIG. 1, ad network 100 includes a plurality of user systems 102A-102M, a plurality of publisher servers 104A-104N, an ad serving system 106, and at least one advertiser system 108. Communication among user systems 102A-102M, publisher servers 104A-104N, ad serving system 106, and advertiser system 108 is carried out over a network using well-known network communication protocols. The network may be a wide-area network (e.g., the Internet), a local area network (LAN), another type of network, or a combination thereof.

User systems 102A-102M are computers or other processing systems, each including one or more processors, that are capable of communicating with any one or more of publisher servers 104A-104N. For example, each of user systems 102A-102M may include a client that enables a user who owns (or otherwise has access to) the user system to access sites (e.g., Web sites) that are hosted by publisher servers 104A-104N. For instance, a client may be a Web crawler, a Web browser, a non-Web-enabled client, or any other suitable type of client. By way of example, each of user systems 102A-102M is shown in FIG. 1 to be communicatively coupled to publisher 1 server(s) 104A for the purpose of accessing a site published by publisher 1. Persons skilled in the relevant art(s) will recognize that each of user systems 102A-102M is capable of connecting to any of publisher servers 104A-104N for accessing the sites hosted thereon.

Publisher servers 104A-104N are computers or other processing systems, each including one or more processors, that are capable of communicating with user systems 102A-102M. Each of publisher servers 104A-104N is configured to host a site (e.g., a Web site) published by a corresponding publisher 1-N so that such site is accessible to users of network 100 via user systems 102A-102M. Each of publisher servers 104A-104N is further configured to serve advertisements (e.g., contextual ads, sponsored ads, display ads, etc.) to users of network 100 when those users access a Web site that is hosted by the respective publisher server.

Publisher servers 104A-104N are further configured to execute software programs that provide information to users in response to receiving requests, such as hypertext transfer protocol (HTTP) requests, from users, instant messaging (IM) applications, or web-based email. For example, the information may include Web pages, images, other types of files, output of executables residing on the publisher servers, IM chat sessions, emails, etc. In accordance with this example, the software programs that are executing on publisher servers 104A-104N may provide Web pages that include interface elements (e.g., buttons, hyperlinks, etc.) that a user may select for accessing the other types of information. The Web pages may be provided as hypertext markup language (HTML) documents and objects (e.g., files) that are linked therein, for example.

One type of software program that may be executed by any one or more of publisher servers 104A-104N is a Web search engine. For instance, publisher 1 server(s) 104A is shown to include search engine module 112, which is configured to execute a Web search engine. Search engine module 112 is capable of searching for information on the World Wide Web (WWW) based on queries that are provided by users. For example, search engine module 112 may search among publisher servers 104A-104N for requested information. Upon discovering instances of information that are relevant to a user's query, search engine module 112 ranks the instances based on their relevance to the query. Search engine module 112 provides a list that includes each of the instances in an order that is based on the respective rankings of the instances. The list may be referred to as the search results corresponding to the query.

Search engine module 112 is configured to provide an ad call to ad serving system 106, upon receiving a query from a user, to request an advertisement (e.g., a contextual ad, a sponsored ad, a display ad, etc.) to be provided to the user. Search engine module 112 forwards a user identifier that corresponds to (e.g., that specifies) the user to ad serving system 106. For example, the user identifier may include a browser cookie of the user or information that is included in the browser cookie. In another example, the user identifier may include a username that is associated with the user. Search engine module 112 may incorporate the user identifier in the ad call or may provide the user identifier in addition to the ad call.

It will be recognized that a search engine module (e.g., search engine module 112) need not necessarily be included in publisher server(s) in order for the publisher server(s) to provide an ad call to ad serving system 1016. For instance, any one or more of publisher servers 104A-104N may provide an ad call to ad serving system 106 without utilizing a search engine module.

Ad serving system 106 is a computer or other processing system, including one or more processors, that is capable of serving advertisements (e.g., contextual ads, sponsored ads, display ads, etc.) that are received from advertiser system 108 to each of publisher servers 104A-104N when the sites hosted by such servers are accessed by certain users, thereby facilitating the delivery of such advertisements to the users. For instance, ad serving system 106 may serve advertisement(s) to a publisher server 104 in response to an ad call that is received from that publisher server 104. The ad call may be initiated in response to a query that is provided by a user. Ad serving system 106 may select an appropriate advertisement to be provided to the user based on a user identifier that is received from search engine module 112.

Ad serving system 106 includes an ad selector 110. Ad selector 110 is configured to select an advertisement (e.g., a contextual ad, a sponsored ad, a display ad, etc.) using user search history segmentation. Ad selector 110 receives an ad call from a publisher server 104. The ad call requests an advertisement to be displayed to a user. Ad selector 110 receives a user identifier that corresponds to the user from the publisher server 104. The user identifier may be included in the ad call or may be received in addition to the ad call. Ad selector 110 may use the user identifier to determine query instances that are included in a search history of the user. For instance, ad selector 110 may access a look-up table and compare the user identifier with information (e.g., metadata) stored in the look-up table that is associated with query instances to determine which of the query instances are included in the user's search history.

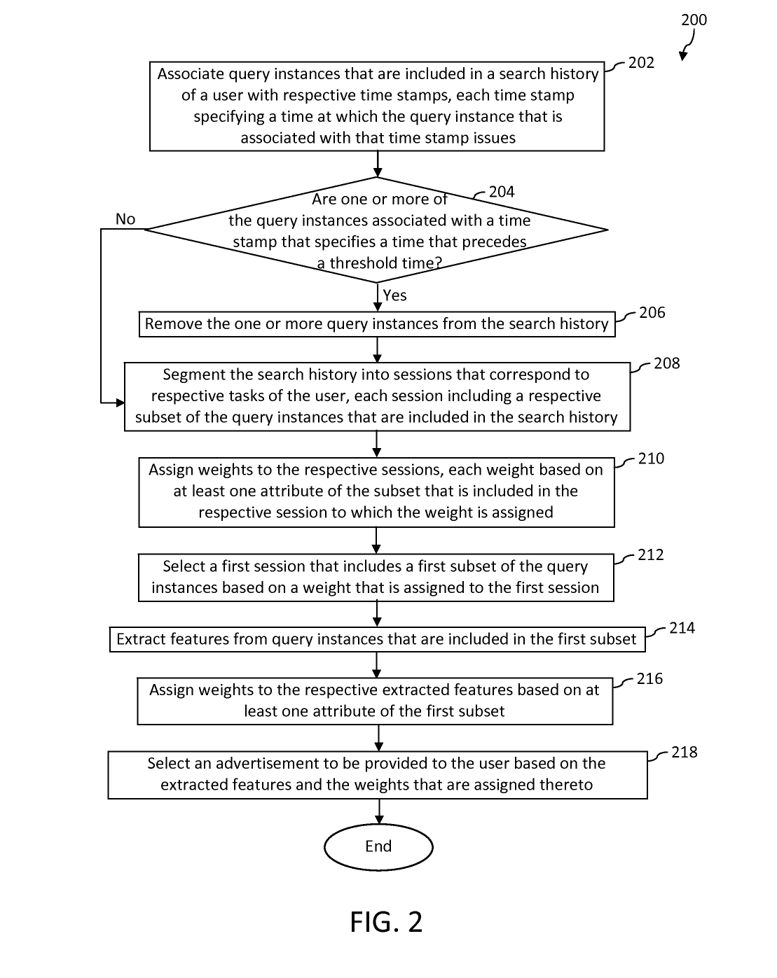

Ad selector 110 segments the search history of the user into sessions that correspond to respective tasks of the user. The sessions include respective subsets of the query instances that are included in the user's search history. Ad selector 110 assigns weights to the respective sessions based on attributes of the sessions. Ad selector 110 selects one or more of the sessions based on the weight(s) that are assigned to the selected session(s). The selected session(s) include a first subset of the query instances that are included in the user's search history. For instance, if multiple sessions are selected, the first subset may include the subsets of the query instances that are included in the respective selected sessions. Ad selector extracts features from the query instances that are included in the first subset and assigns weights to the extracted features based on various attributes. Ad selector then selects an advertisement to be provided to the user based on the extracted features and their assigned weights. Techniques for selecting an advertisement using user search history segmentation are described in further detail below with reference to FIGS. 2-14.

Advertiser system 108 is a computer or other processing system, including one or more processors, that is capable of providing advertisements (e.g., contextual ads, sponsored ads, display ads, etc.) to ad serving system 106, so that the advertisements may be served to publisher servers 104A-104N when the sites hosted by the respective servers are accessed by certain users. Although one advertiser system 108 is depicted in FIG. 1, persons skilled in the relevant art(s) will recognize that any number of advertiser systems may be communicatively coupled to ad serving system 106.

Although advertiser system 108 and user systems 102A-102M are depicted as desktop computers in FIG. 1, persons skilled in the relevant art(s) will appreciate that advertiser system 108 and user systems 102A-102M may include any browser-enabled system or device, including but not limited to a laptop computer, a tablet computer, a personal digital assistant, a cellular telephone, or the like.

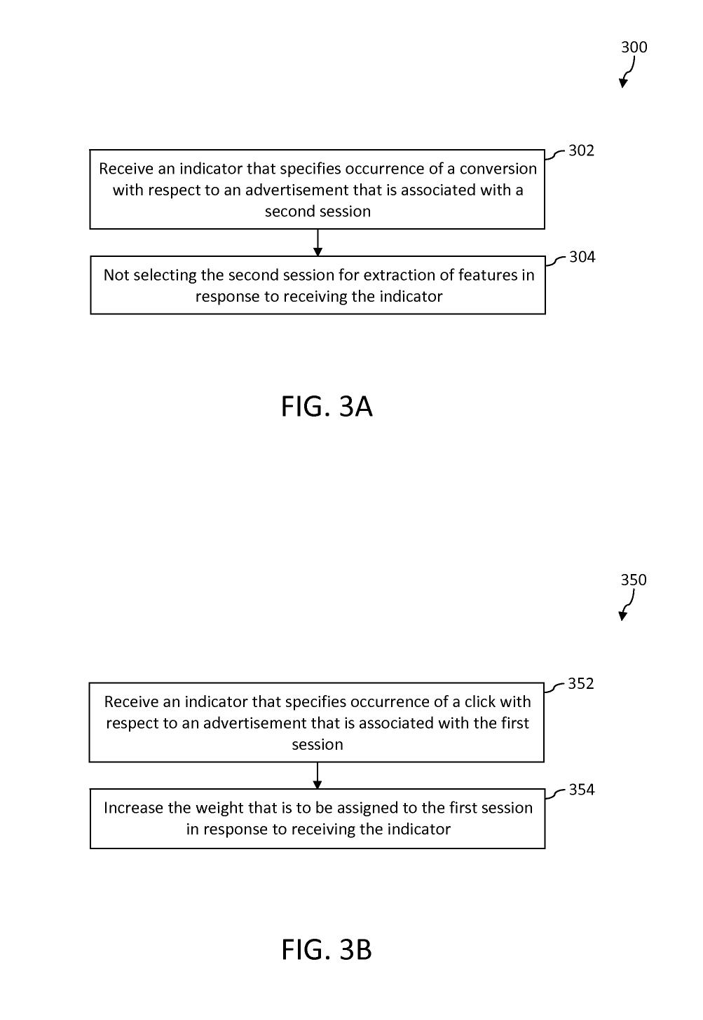

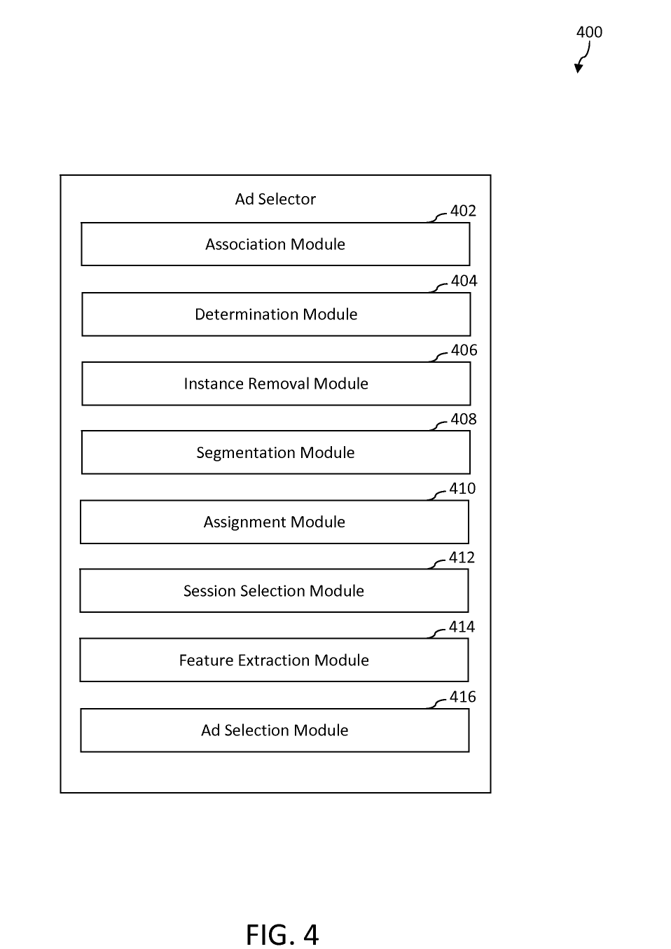

FIGS. 2 and 3 depict flowcharts 200 and 300 of example methods for selecting an advertisement using user search history segmentation in accordance with embodiments described herein. Flowcharts 200 and 300 may be performed by ad selector 110 of ad network 100 shown in FIG. 1, for example. For illustrative purposes, flowcharts 200 and 300 are described with respect to an ad selector 400 shown in FIG. 4, which is an example of an ad selector 110, according to an embodiment. As shown in FIG. 4, ad selector 400 includes an association module 402, a determination module 404, an instance removal module 406, a segmentation module 408, an assignment module 410, a session selection module 412, a feature extraction module 414, and an ad selection module 416. Further structural and operational embodiments will be apparent to persons skilled in the relevant art(s) based on the discussion regarding flowcharts 200 and 300.

As shown in FIG. 2, the method of flowchart 200 begins at step 202. In step 202, query instances that are included in a search history of a user are associated with respective time stamps. Each time stamp specifies a time at which the query instance that is associated with that time stamp issues. In an example implementation, association module 402 associates the query instances that are included in the search history with respective time stamps.

At step 204, a determination is made whether one or more of the query instances are associated with a time stamp that specifies a time that precedes a threshold time. The threshold time may be updated on a real-time or periodic (e.g., daily, hourly, etc.) basis, though the scope of the example embodiments is not limited in this respect. In an example implementation, determination module 404 determines whether one or more of the query instances are associated with a time stamp that specifies a time that precedes the threshold time. If one or more of the query instances are associated with a time stamp that specifies a time that precedes the threshold time, flow continues to step 206. Otherwise, flow continues to step 208.

At step 206, the one or more query instances are removed from the search history. In an example implementation, instance removal module 406 removes the one or more query instances from the search history.

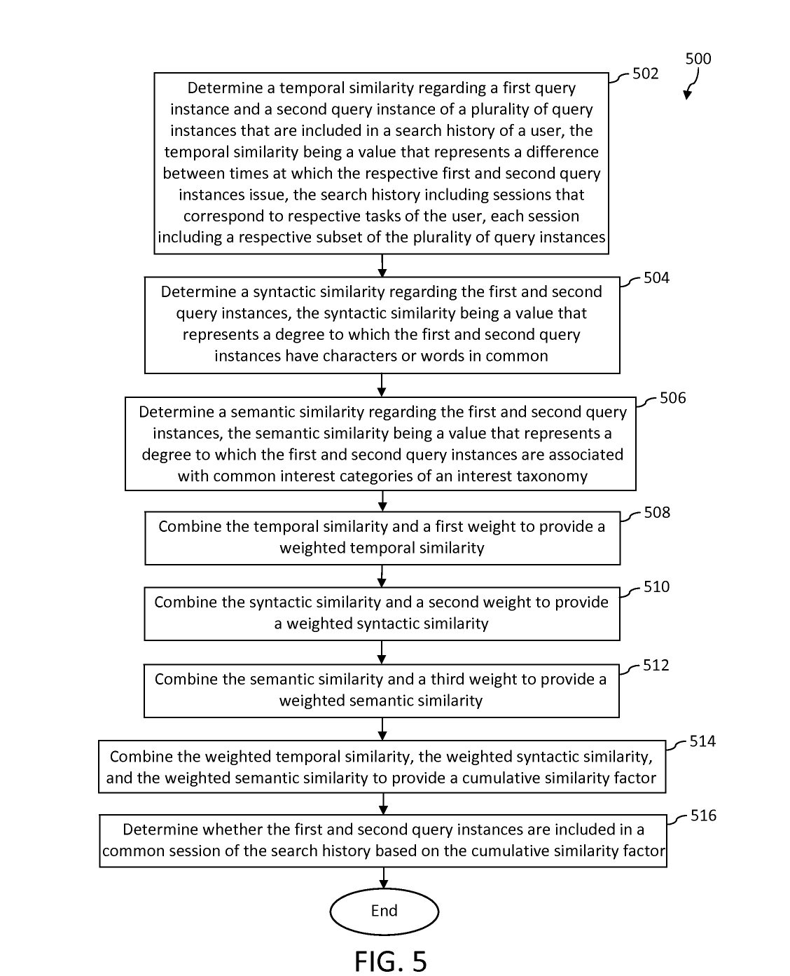

At step 208, the search history is segmented into sessions that correspond to respective tasks of the user. Each session includes a respective subset of the query instances that are included in the search history. In an example implementation, segmentation module 408 segments the search history into sessions that correspond to respective tasks of the user. Query instances pertaining to various tasks of the user may be interleaved in the search history of the user, though the scope of the example embodiments is not limited in this respect. For instance, the search history may include some query instances that pertain to a “car shopping” task, followed by a query instance for navigating to mail.yahoo.com, followed by more query instances that pertain to the “car shopping” task, and so on. Accordingly, query instances (e.g., adjacent query instances) that are included in the user's search history may be analyzed to determine whether the query instances are included in a common session of the search history. Some example techniques for determining whether query instances are included in a common session of a search history are described below with reference to FIGS. 5-11.

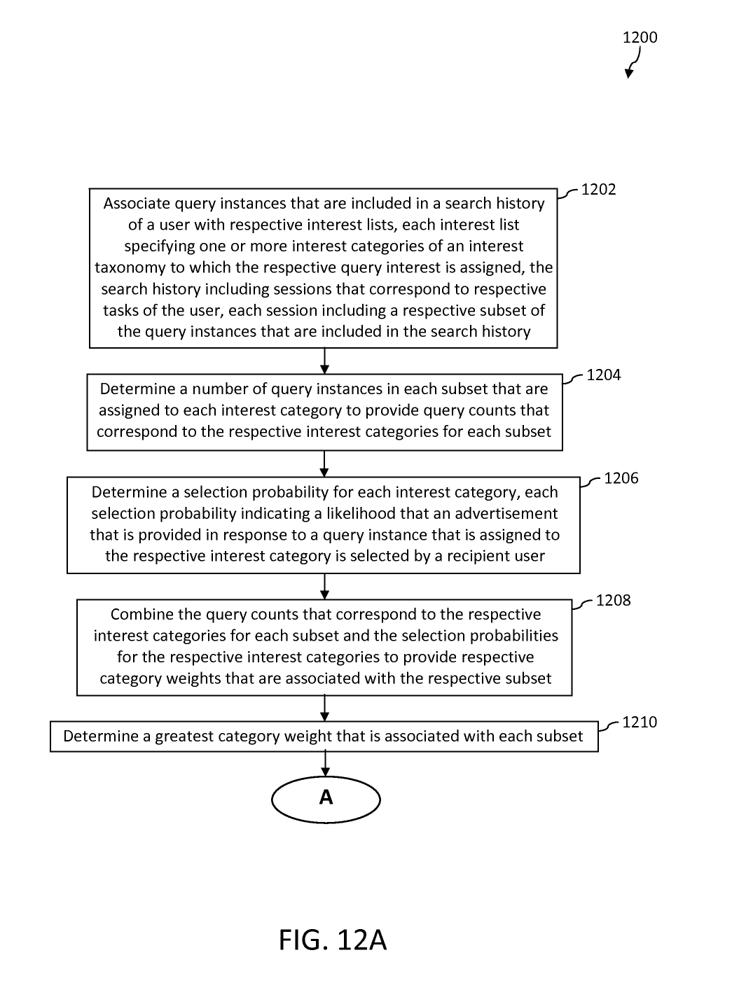

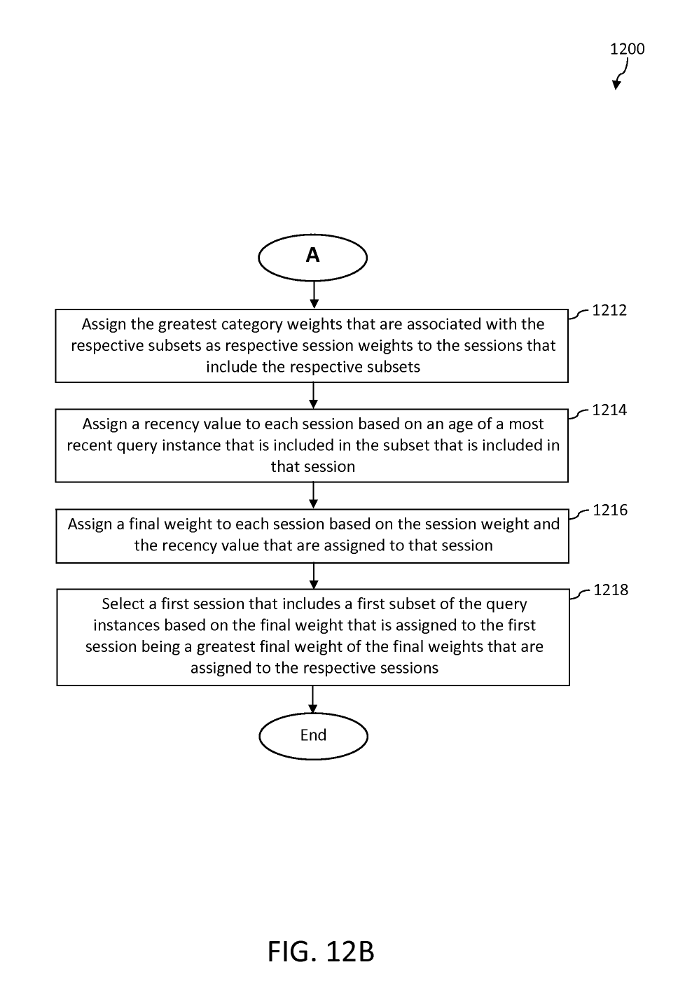

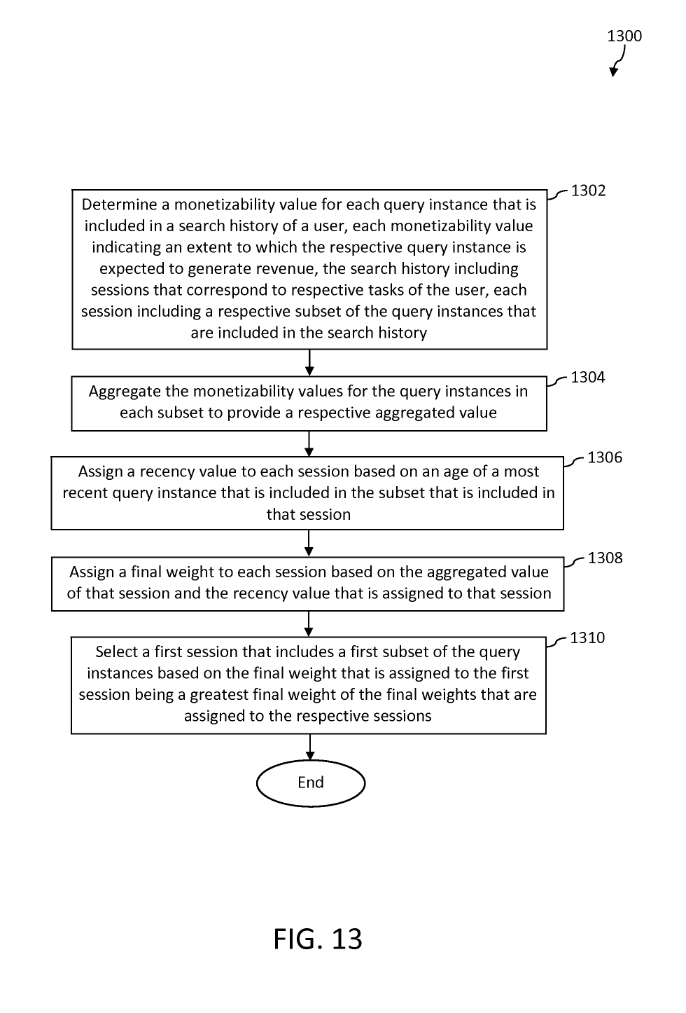

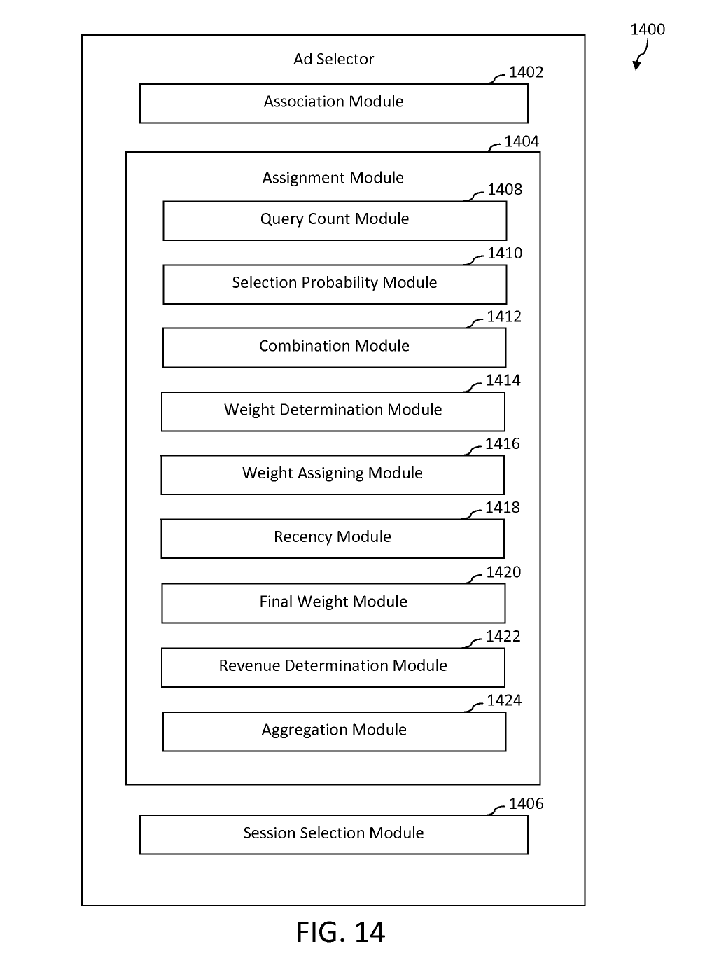

At step 210, weights are assigned to the respective sessions. Each weight is based on at least one attribute of the subset that is included in the respective session to which the weight is assigned. Some example attributes include but are not limited to the monetizability and recency of the session. Some example techniques to determine the monetizability of a session based on attributes associated with the query instances in the session are described below with reference to FIGS. 13 and 14. Recency indicates an age of a most recent query instance that is included in the subset. An age of a query instance is a time period that begins when the query instance is issued and ends at a reference time (e.g., the present time). For example, if a query instance issued 49.3 hours ago, the age of that query instance may be said to be 49.3 hours. The age of a query instance may be measured in any suitable units of measure, including but not limited to milliseconds, seconds, minutes, hours, days, etc. These and other example attributes upon which a weight may be based are described in further detail below with reference to FIGS. 12-14. In an example implementation, assignment module 410 assigns the weights to the respective sessions.

At step 212, a first session that includes a first subset of the query instances is selected based on a weight that is assigned to the first session. For example, the first session may be selected based on the weight that is assigned to the first session being a greatest weight of the weights that are assigned to the respective sessions. In an example implementation, session selection module 412 selects the first session based on the weight that is assigned to the first session.

In accordance with example embodiments, the first session is selected based on factors in addition to or in lieu of the weight that is assigned to the first session. For example, the first session may be selected based on a probabilistic selection technique. A probabilistic selection technique is a technique in which weights that are assigned to respective sessions correspond to probabilities of the respective sessions to be selected for purposes of extracting features from query instances therein. In accordance with this example, if the weight that is assigned to the first session is 80 and a weight that is assigned to a second session is 20, session selection module 412 may be configured to select the first session 80% of the time and to select the second session 20% of the time.

At step 214, features are extracted from query instances that are included in the first subset. A feature of a query instance includes information regarding the query instance. Some example types of features include but are not limited to a keyword feature, a key phrase feature, etc. A keyword feature of a query instance specifies a word that is included in the query instance. A key phrase feature of a query instance specifies two or more adjacent words in the query instance. In an example implementation, feature extraction module 414 extracts the features from the query instances that are included in the first subset.

At step 216, weights are assigned to the extracted features based on at least one attribute of the first subset. Some examples of an attribute include but are not limited to an inverse document frequency, a term frequency, monetizability, etc. An inverse document frequency indicates a rarity of a word or a phrase that is included in query instance(s) of the subset. A term frequency indicates a number of instances of a word or a phrase in the query instance(s) of the subset. For instance, if the word “BMW” occurs in five query instances of a plurality of query instance, the term frequency of the word “BMW” is five or a function of five (e.g., log(5)). Monetizability indicates an extent to which query instance(s) of the subset are expected to generate revenue. For example, the monetizability of a subset may indicate an amount of revenue that is expected to be obtained based on one or more keywords and/or key phrases that are included in the query instance(s) of the subset. In another example, the monetizability of a subset may be based on one or more click-through rates that are associated with one or more respective keywords and/or key phrases that are included in the query instance(s) of the subset. In an example implementation, assignment module 410 assigns the weights to the respective extracted features.

At step 218, an advertisement is selected to be provided to the user based on the extracted features and the weights that are assigned thereto. The advertisement may be selected further based on a context of a web page with respect to which the advertisement is to be provided, though the scope of the example embodiments is not limited in this respect. In an example implementation, ad selection module 416 selects the advertisement to be provided to the user based on the extracted features and the weights that are assigned thereto.

In some example embodiments, one or more steps 202, 204, 206, 208, 210, 212, 214, 216, and/or 218 of flowchart 200 may not be performed. Moreover, steps in addition to or in lieu of steps 202, 204, 206, 208, 210, 212, 214, 216, and/or 218 may be performed. For example, FIG. 3A depicts a flowchart 300 that includes steps 302 and 304, which may be incorporated into flowchart 200.

As shown in FIG. 3A, the method of flowchart 300 begins at step 302. In step 302, an indicator is received that specifies occurrence of a conversion with respect to an advertisement that is associated with a second session. For instance, the conversion may signify completion of a task to which the second session corresponds. In an example implementation, session selection module 412 receives the indicator that specifies the occurrence of the conversion with respect to an advertisement that is associated with the second session.

At step 304, the second session is not selected for extraction of features in response to receiving the indicator. In an example implementation, session selection module 412 does not select the second session.

In another example, FIG. 3B depicts a flowchart 350 that includes steps 352 and 354, which may be incorporated into flowchart 200. As shown in FIG. 3B, the method of flowchart 350 begins at step 352. In step 352, an indicator is received that specifies an occurrence of a click with respect to an advertisement that is associated with the first session. In an example implementation, assignment module 410 receives the indicator that specifies the occurrence of the click with respect to an advertisement that is associated with the first session.

At step 354, the weight that is to be assigned to the first session is increased in response to receiving the indicator. In an example implementation, assignment module 410 increases the weight that is to be assigned to the first session. Any of a variety of techniques may be used to determine an extent to which the weight that is to be assigned to the first session is to be increased at step 304. For example, historical click data may be used to determine the extent to which the weight that is to be assigned to the first session is to be increased.

In accordance with an example embodiment, the plurality of sessions is monitored in substantially real-time to determine whether a conversion and/or a click has occurred with respect to any of the sessions. In further accordance with this example embodiment, steps 302 and 304 of flowchart 300 may be performed each time a conversion occurs, and/or steps 352 and 354 of flowchart 350 may be performed each time a click occurs.

It will be recognized that ad selector 400 may not include one or more of association module 402, determination module 404, instance removal module 406, segmentation module 408, assignment module 410, session selection module 412, feature extraction module 414, and/or ad selection module 416. Furthermore, ad selector 400 may include modules in addition to or in lieu of association module 402, determination module 404, instance removal module 406, segmentation module 408, assignment module 410, session selection module 412, feature extraction module 414, and/or ad selection module 416.

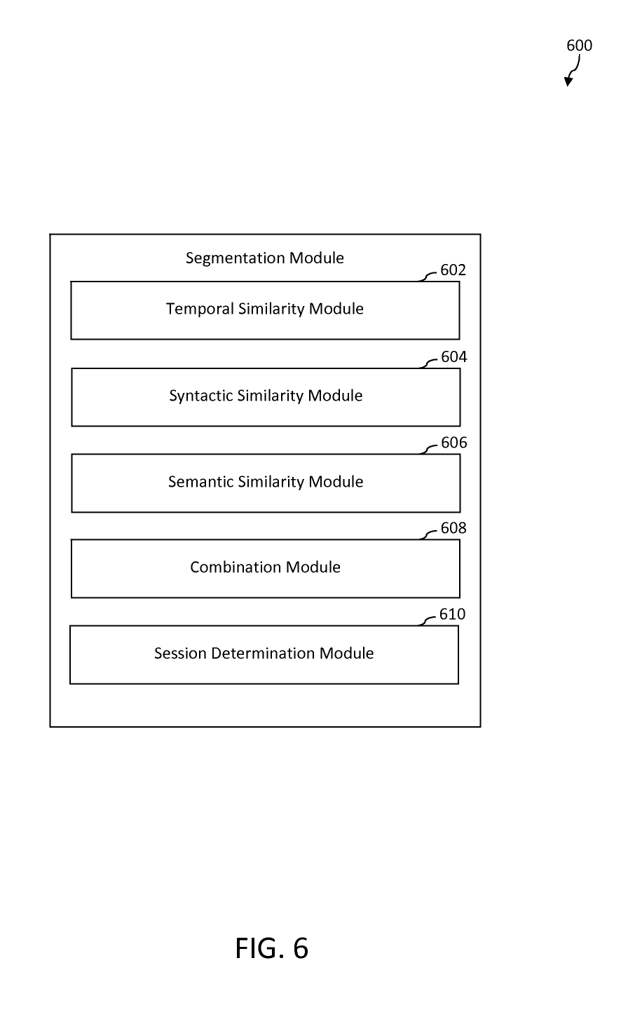

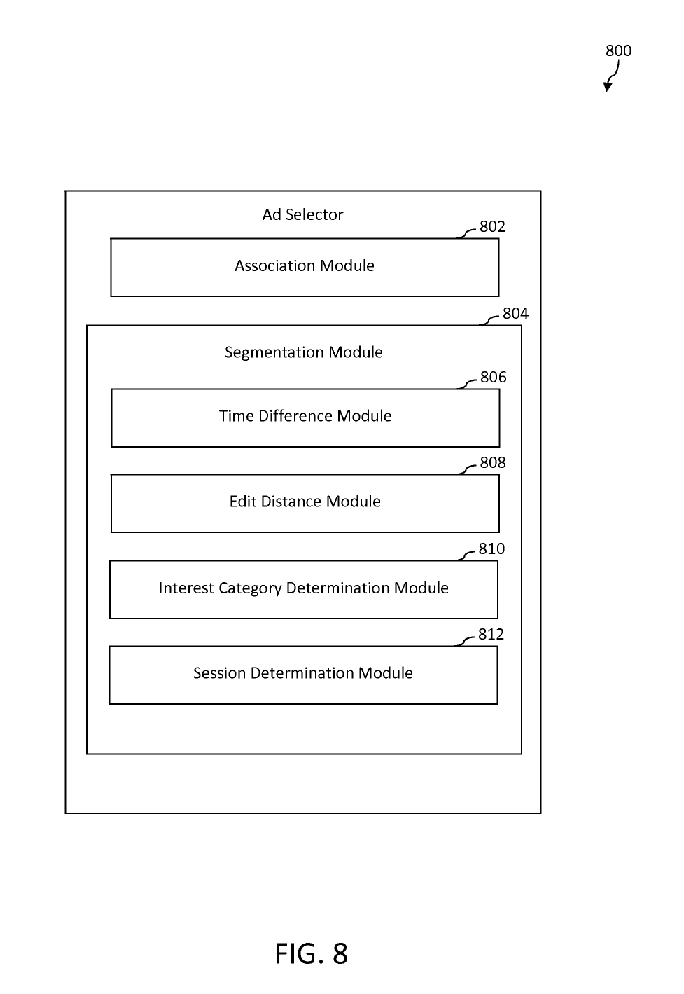

FIG. 5 depicts another flowchart 500 of an example method for selecting an advertisement using user search history segmentation in accordance with embodiments described herein. Flowchart 500 may be performed by segmentation module 408 shown in FIG. 4 or segmentation module 804 shown in FIG. 8, for example. For illustrative purposes, flowchart 500 is described with respect to a segmentation module 600 shown in FIG. 6, which is an example of a segmentation module 408 or 804, according to an embodiment. As shown in FIG. 6, segmentation module 600 includes a temporal similarity module 602, a syntactic similarity module 604, a semantic similarity module 606, a combination module 608, and a session determination module 610. Further structural and operational embodiments will be apparent to persons skilled in the relevant art(s) based on the discussion regarding flowchart 500.

As shown in FIG. 5, the method of flowchart 500 begins at step 502. In step 502, a temporal similarity is determined regarding a first query instance and a second query instance of a plurality of query instances that are included in a search history of a user. The temporal similarity is a value that represents a difference between times at which the respective first and second query instances issue. The search history includes sessions that correspond to respective tasks of the user. Each session includes a respective subset of the plurality of query instances. In an example implementation, temporal similarity module 602 determines the temporal similarity regarding the first query instance and the second query instance.

At step 504, a syntactic similarity is determined regarding the first and second query instances. The syntactic similarity is a value that represents a degree to which the first and second query instances have characters or words in common. In an example implementation, syntactic similarity module 604 determines the syntactic similarity regarding the first query instance and the second query instance.

At step 506, a semantic similarity is determined regarding the first and second query instances. The semantic similarity is a value that represents a degree to which the first and second query instances are associated with common interest categories of an interest taxonomy. In an example implementation, semantic similarity module 606 determines the semantic similarity regarding the first query instance and the second query instance.

At step 508, the temporal similarity and a first weight are combined to provide a weighted temporal similarity. In an example implementation, combination module 608 combines the temporal similarity and the first weight to provide the weighted temporal similarity.

At step 510, the syntactic similarity and a second weight are combined to provide a weighted syntactic similarity. In an example implementation, combination module 608 combines the syntactic similarity and the second weight to provide the weighted syntactic similarity.

At step 512, the semantic similarity and a third weight are combined to provide a weighted semantic similarity. In an example implementation, combination module 608 combines the semantic similarity and the third weight to provide the weighted semantic similarity.

At step 514, the weighted temporal similarity, the weighted syntactic similarity, and the weighted semantic similarity are combined to provide a cumulative similarity factor. In an example implementation, combination module 608 combines the weighted temporal similarity, the weighted syntactic similarity, and the weighted semantic similarity to provide the cumulative similarity factor. Any of a variety of techniques may be used to combine the weighted temporal similarity, the weighted syntactic similarity, and the weighted semantic similarity. For example, heuristics may be used to combine these weighted similarities. In another example, user query logs are analyzed, so that query instances therein may be matched to tasks using human editorial input. In accordance with this example, the weights are learned using a supervised learning classifier.

At step 516, a determination is made whether the first and second query instances are included in a common session of the search history based on the cumulative similarity factor. It will be recognized that the determination that is made at step 516 may be based on factor(s) in addition to the cumulative similarity factor. In an example implementation, session determination module 610 determines whether the first and second query instances are included in a common session of the search history based on the cumulative similarity factor.

In some example embodiments, one or more steps 502, 504, 506, 508, 510, 512, 514, and/or 516 of flowchart 500 may not be performed. Moreover, steps in addition to or in lieu of steps 502, 504, 506, 508, 510, 512, 514, and/or 516 may be performed. In accordance with such example embodiments, the weighted temporal similarity, the weighted syntactic similarity, and the weighted semantic similarity need not necessarily be combined at step 514. For instance, any two or more of the weighted temporal similarity, the weighted syntactic similarity, and/or the weighted semantic similarity may be combined at step 514 to provide the cumulative similarity factor. Moreover, any one or more of the weighted temporal similarity, the weighted syntactic similarity, and/or the weighted semantic similarity may be replaced with the respective temporal similarity, syntactic similarity, and/or semantic similarity in step 514.

It will be recognized that segmentation module 600 may not include one or more of temporal similarity module 602, syntactic similarity module 604, semantic similarity module 606, combination module 608, and/or session determination module 610. Furthermore, segmentation module 600 may include modules in addition to or in lieu of temporal similarity module 602, syntactic similarity module 604, semantic similarity module 606, combination module 608, and/or session determination module 610.

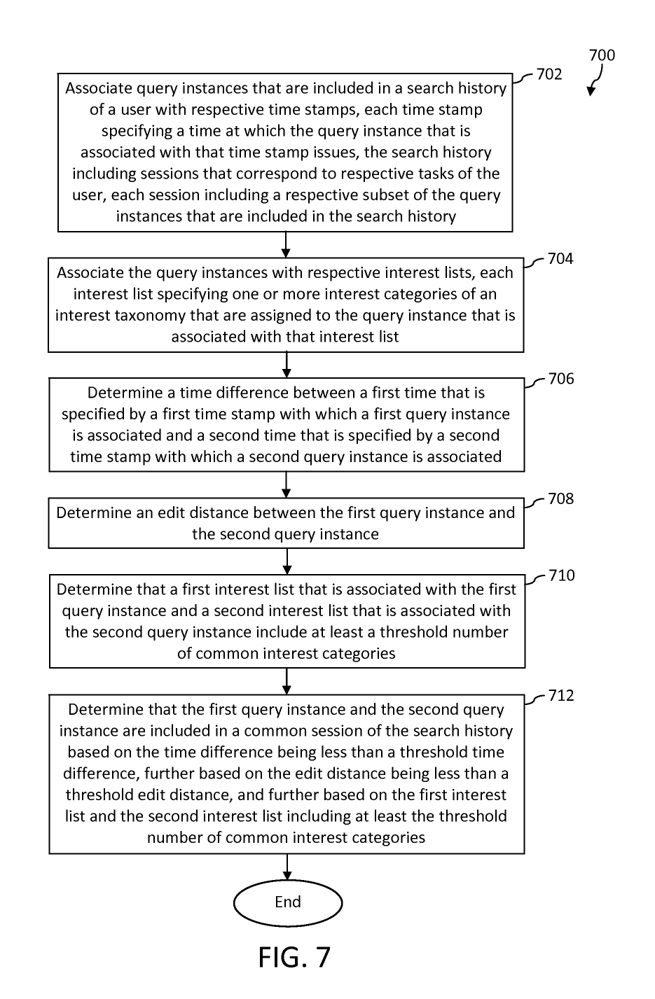

FIG. 7 depicts another flowchart 700 of an example method for selecting an advertisement using user search history segmentation in accordance with embodiments described herein. Flowchart 700 may be performed by ad selector 110 of ad network 100 shown in FIG. 1, for example. For illustrative purposes, flowchart 700 is described with respect to an ad selector 800 shown in FIG. 8, which is an example of an ad selector 110, according to an embodiment. As shown in FIG. 8, ad selector 800 includes an association module 802 and a segmentation module 804. Segmentation module 804 includes a time difference module 806, an edit distance module 808, an interest category determination module 810, and a session determination module 812. Further structural and operational embodiments will be apparent to persons skilled in the relevant art(s) based on the discussion regarding flowchart 700.

As shown in FIG. 7, the method of flowchart 700 begins at step 702. In step 702, query instances that are included in a search history of a user are associated with respective time stamps. Each time stamp specifies a time at which the query instance that is associated with that time stamp issues. The search history includes sessions that correspond to respective tasks of the user. Each session includes a respective subset of the query instances that are included in the search history. In an example implementation, association module 802 associates the query instances that are included in the search history of the user with the respective time stamps.

At step 704, the query instances are associated with respective interest lists. Each interest list specifies one or more interest categories of an interest taxonomy that are assigned to the query instance that is associated with that interest list. In an example implementation, association module 802 associates the query instances with the respective interest lists.

An example interest taxonomy will now be described. This example interest taxonomy includes first, second, and third hierarchical interest levels for illustrative purposes. The first hierarchical interest level includes interest categories of finance and sports. The finance interest category includes interest categories of insurance, retirement, and job searching, all of which are included in the second hierarchical interest level. The sports interest category includes interest categories of basketball, hockey, football, and soccer, all of which are also included in the second hierarchical interest level. The insurance interest category includes interest categories of home, car, life, health, and disability, all of which are included in the third hierarchical interest level. An interest list that is associated with a query instance of “car insurance agent”, for example, may specify the interest category of “finance/insurance/car”. The example interest taxonomy and interest categories described above are provided for illustrative purposes and are not intended to limit the scope of the example embodiments. The techniques described herein are applicable to any suitable interest taxonomy. For instance, the interest taxonomy may include any number of interest levels, interest categories, etc., which may be different from (or the same as) those described above.

At step 706, a time difference is determined between a first time that is specified by a first time stamp with which a first query instance is associated and a second time that is specified by a second time stamp with which a second query instance is associated. In an example implementation, time difference module 806 determines the time difference between the first time and the second time.

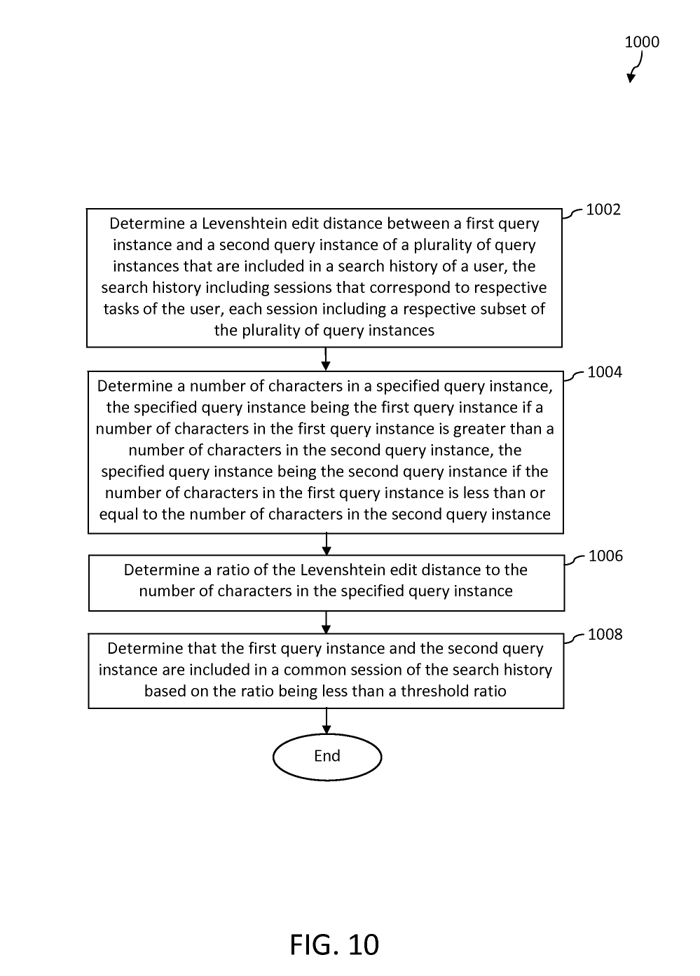

At step 708, an edit distance is determined between the first query instance and the second query instance. Example types of an edit distance include but are not limited to a Jaro edit distance, a Jaro-Winkler edit distance, a Levenshtein edit distance, and a Wagner-Fischer edit distance. The edit distance may be normalized or non-normalized. One example technique for normalizing an edit distance is described below with reference to steps 1002, 1004, and 1006 of FIG. 10. In an example implementation, edit distance module 808 determines the edit distance between the first query instance and the second query instance.

At step 710, a determination is made that a first interest list that is associated with the first query instance and a second interest list that is associated with the second query instance include at least a threshold number of common interest categories. The threshold number may be any suitable number, such as one, two, three, etc. In an example implementation, interest category determination module 810 determines that the first interest list and the second interest list include at least the threshold number of common interest categories.

At step 712, a determination is made that the first query instance and the second query instance are included in a common session of the search history based on the time difference being less than a threshold time difference. The determination is further based on the edit distance being less than a threshold edit distance. The determination is further based on the first interest list and the second interest list including at least the threshold number of common interest categories. In an example implementation, session determination module 812 determines that the first query instance and the second query instance are included in a common session.

In some example embodiments, one or more steps 702, 704, 706, 708, 710, and/or 712 of flowchart 700 may not be performed. Moreover, steps in addition to or in lieu of steps 702, 704, 706, 708, 710, and/or 712 may be performed. In accordance with such example embodiments, the determination that is made at step 712 need not necessarily be based on the time difference being less than the threshold time difference, the edit distance being less than the threshold edit distance, and the first interest list and the second interest list including at least the threshold number of common interest categories. For instance, the determination that is made at step 712 may be based on any one or more of the time difference being less than the threshold time difference, the edit distance being less than the threshold edit distance, and/or the first interest list and the second interest list including at least the threshold number of common interest categories. Furthermore, the determination at step 516 may be based on factor(s) in addition to one or more of the time difference being less than the threshold time difference, the edit distance being less than the threshold edit distance, and/or the first interest list and the second interest list including at least the threshold number of common interest categories.

It will be recognized that ad selector 800 may not include one or more of association module 802, segmentation module 804, time difference module 806, edit distance module 808, interest category determination module 810, and/or session determination module 812. Furthermore, ad selector 800 may include modules in addition to or in lieu of association module 802, segmentation module 804, time difference module 806, edit distance module 808, interest category determination module 810, and/or session determination module 812.

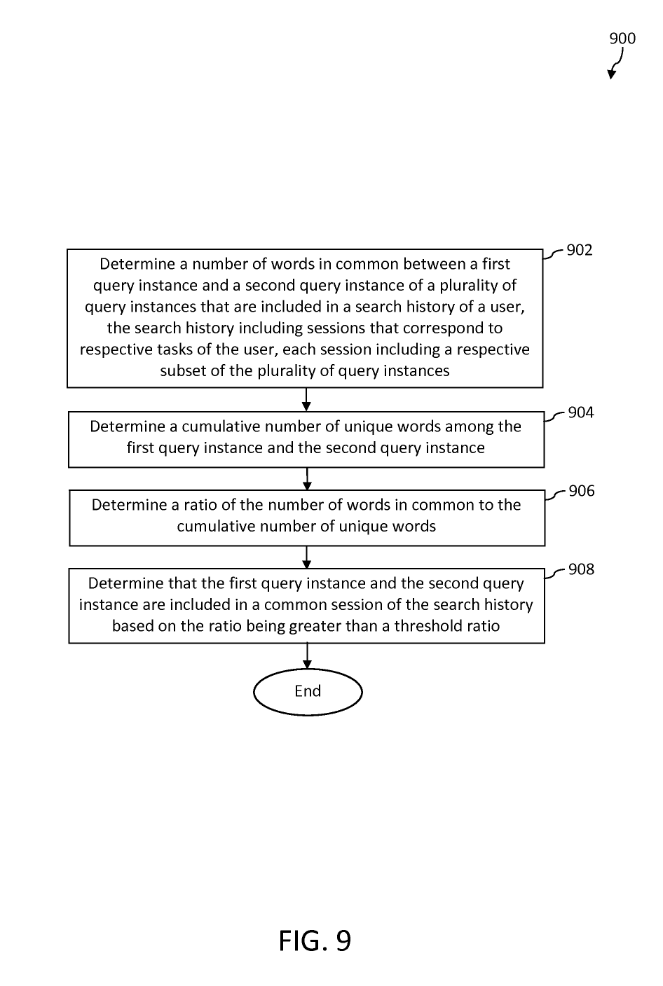

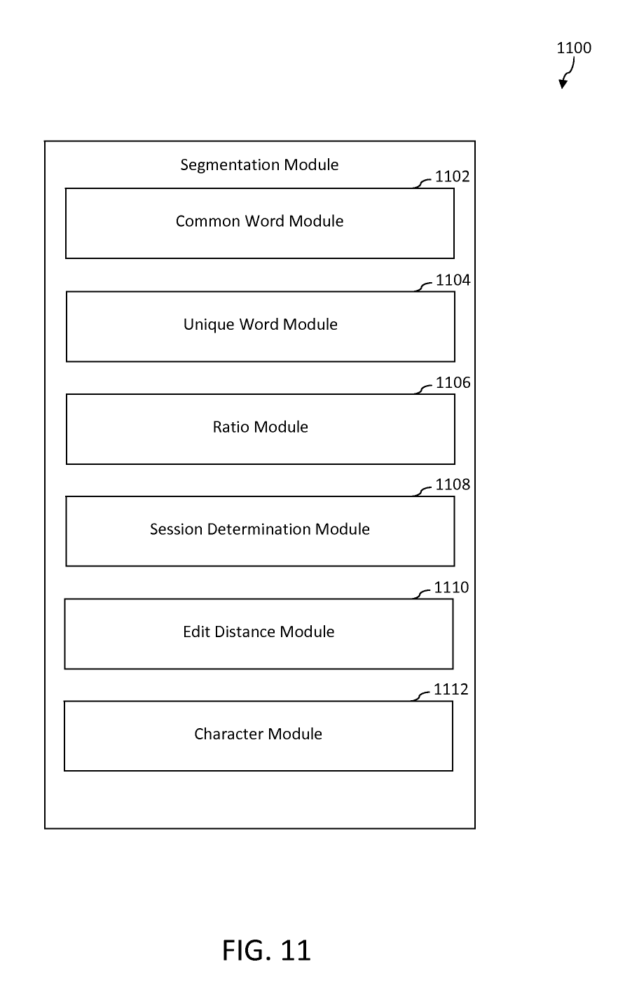

FIGS. 9 and 10 depict flowcharts 900 and 1000 of example methods for selecting an advertisement using user search history segmentation in accordance with embodiments described herein. Flowcharts 900 and 1000 may be performed by segmentation module 408 shown in FIG. 4 or segmentation module 804 shown in FIG. 8, for example. For illustrative purposes, flowcharts 900 and 1000 are described with respect to a segmentation module 1100 shown in FIG. 11, which is an example of a segmentation module 408 or 804, according to an embodiment. As shown in FIG. 11, segmentation module 1100 includes a common word module 1102, a unique word module 1104, a ratio module 1106, a session determination module 1108, an edit distance module 1110, and a character module 1112. Further structural and operational embodiments will be apparent to persons skilled in the relevant art(s) based on the discussion regarding flowcharts 900 and 1000.

As shown in FIG. 9, the method of flowchart 900 begins at step 902. In step 902, a number of words in common between a first query instance and a second query instance of a plurality of query instances that are included in a search history of a user is determined For example, if the first query instance is “car insurance quote” and the second query instance is “auto insurance agent”, the number of words in common between the first query instance and the second query instance is one. In accordance with this example, the word that the first and second query instances have in common is “insurance”. The example query instances mentioned above are provided for illustrative purposes and are not intended to be limiting. It will be recognized that the each of the first and second query instances may include any suitable combination and/or number of words (e.g., one, two, three, etc.). The search history includes sessions that correspond to respective tasks of the user. Each session includes a respective subset of the plurality of query instances. In an example implementation, common word module 1002 determines the number of words in common between the first query instance and the second query instance.

At step 904, a cumulative number of unique words among the first query instance and the second query instance is determined In the example mentioned above in which the first query instance is “car insurance quote” and the second query instance is “auto insurance agent”, the cumulative number of unique words among the first and second query instances is five. The unique words are “car”, “insurance”, “quote”, “auto”, and “agent”. Accordingly, it can be seen that occurrences of a word among the first and second query instances beyond the first occurrence of the word are not counted for purposes of determining the cumulative number of unique words among the first and second query instances. In an example implementation, unique word module 1004 determines the cumulative number of unique words among the first query instance and the second query instance.

At step 906, a ratio of the number of words in common to the cumulative number of unique words is determined In the example mentioned above in which the first query instance is “car insurance quote” and the second query instance is “auto insurance agent”, the ratio of words in common to the cumulative number of unique words is ⅕=0.2=20%. In an example implementation, ratio module 1006 determines the ratio of the number of words in common to the cumulative number of unique words.

At step 908, a determination is made that the first query instance and the second query instance are included in a common session of the search history based on the ratio being greater than a threshold ratio. It will be recognized that the determination that is made at step 908 may be based on factor(s) in addition to the ratio being greater than the threshold ratio. In the example mentioned above in which the first query instance is “car insurance quote” and the second query instance is “auto insurance agent”, the first and second query instances are determined to be included in a common session of the search history if the threshold is less than 0.2. In an example implementation, session determination module 1008 determines that the first query instance and the second query instance are included in a common session of the search history based on the ratio being greater than the threshold ratio.

As shown in FIG. 10, the method of flowchart 1000 begins at step 1002. In step 1002, a Levenshtein edit distance between a first query instance and a second query instance of a plurality of query instances that are included in a search history of a user is determined A Levenshtein edit distance is a minimum number of allowable edits that need to be performed with respect to characters of a first query instance to cause the first query instance to be the same as a second query instance. Each allowable edit is an insertion of a single character, a deletion of a single character, or a substitution of a first single character for a second single character. The search history includes sessions that correspond to respective tasks of the user. Each session includes a respective subset of the plurality of query instances. In an example implementation, edit distance module 1010 determines the Levenshtein edit distance between the first query instance and the second query instance.

At step 1004, a number of characters in a specified query instance is determined. The specified query instance is the first query instance if a number of characters in the first query instance is greater than a number of characters in the second query instance. The specified query instance is the second query instance if the number of characters in the first query instance is less than or equal to the number of characters in the second query instance. In an example implementation, character module 1012 determines the number of characters in the specified query instance.

In accordance with an example embodiment, step 1004 is changed such that the specified query instance is the first query instance if the number of characters in the first query instance is greater than or equal to the number of characters in the second query instance. In further accordance with this example embodiment, the specified query instance is the second query instance if the number of characters in the first query instance is less than the number of characters in the second query instance.

At step 1006, a ratio of the Levenshtein edit distance to the number of characters in the specified query instance is determined. In an example implementation, ratio module 1006 determines the ratio of the Levenshtein edit distance to the number of characters sin the specified query instance.

At step 1008, a determination is made that the first query instance and the second query instance are included in a common session of the search history based on the ratio being less than a threshold ratio. It will be recognized that the determination that is made at step 1008 may be based on factor(s) in addition to the ratio being less than the threshold ratio. In an example implementation, session determination module 1008 determines that the first query instance and the second query instance are included in a common session of the search history based on the ratio being less than the threshold ratio.

The factors described above with respect to FIGS. 9 and 10 for determining that a first query instance and a second query instance are included in a common session of a search history are provided for illustrative purposes and are not intended to be limiting. Persons skilled in the relevant art(s) will recognize that any suitable factors may be used to determine whether query instances are included in a common session of a search history. Examples of some factors that may be used in addition to or in lieu of the factors described above for determining that first and second query instances are included in a common session of a search history include but are not limited to a Jaccard index, a Tanimoto coefficient, a Sorensen's quotient of similarity, etc. with respect to the first and second query instances.

It will be further recognized that segmentation module 1100 may not include one or more of common word module 1102, unique word module 1104, ratio module 1106, session determination module 1108, edit distance module 1110, and/or character module 1112. Furthermore, segmentation module 1100 may include modules in addition to or in lieu of common word module 1102, unique word module 1104, ratio module 1106, session determination module 1108, edit distance module 1110, and/or character module 1112.

FIGS. 12A-12B and 13 depict flowcharts 1200 and 1300 of example methods for selecting an advertisement using user search history segmentation in accordance with embodiments described herein. Flowcharts 1200 and 1300 may be performed by ad selector 110 of ad network 100 shown in FIG. 1, for example. For illustrative purposes, flowcharts 1200 and 1300 are described with respect to an ad selector 1400 shown in FIG. 14, which is an example of an ad selector 110, according to an embodiment. As shown in FIG. 14, ad selector 1400 includes an association module 1402, an assignment module 1404, and a session selection module 1406. Assignment module 1404 includes a query count module 1408, a selection probability module 1410, a combination module 1412, a weight determination module 1414, a weight assigning module 1416, a recency module 1418, a final weight module 1420, a revenue determination module 1422, and an aggregation module 1424. Further structural and operational embodiments will be apparent to persons skilled in the relevant art(s) based on the discussion regarding flowcharts 1200 and 1300.

As shown in FIG. 12A, the method of flowchart 1200 begins at step 1202. In step 1202, query instances that are included in a search history of a user are associated with respective interest lists. Each interest list specifies one or more interest categories of an interest taxonomy to which the respective query interest is assigned. The search history includes sessions that correspond to respective tasks of the user. Each session includes a respective subset of the query instances that are included in the search history. In an example implementation, association module 1402 associates the query instances that are included in the search history with the respective interest lists.

At step 1204, a number of query instances in each subset that are assigned to each interest category is determined to provide query counts that correspond to the respective interest categories for each subset. For example, a first subset may include four query instances that are assigned to a first interest category, seven query instances that are assigned to a second interest category, three query instances that are assigned to a third interest category, and no query instances that are assigned to a fourth interest category. In this example, a second subset may include two query instances that are assigned to the first interest category, one query instance that is assigned to the second interest category, no query instances that are assigned to the third interest category, and thirteen query instances that are assigned to the fourth interest category. In accordance with this example, the query counts for the first subset are four, seven, three, and zero, corresponding to the respective first, second, third, and fourth interest categories. In further accordance with this example, the query counts for the second subset are two, one, zero, and thirteen, corresponding to the respective first, second, third, and fourth interest categories. In an example implementation, query count module 1408 determines the number of query instances in each subset that are assigned to each interest category to provide the query counts that correspond to the respective interest categories for each subset.

At step 1206, a selection probability is determined for each interest category. Each selection probability indicates a likelihood that an advertisement that is provided in response to a query instance that is assigned to the respective interest category is selected by a recipient user. For example, a selection probability may be determined based on an expected click-through rate that is associated with the respective interest category, an expected revenue that is associated with the respective interest category, etc. In an example implementation, selection probability module 1410 determines the selection probability for each interest category.

At step 1208, the query counts that correspond to the respective interest categories for each subset and the selection probabilities for the respective interest categories are combined to provide respective category weights that are associated with the respective subset. In an example implementation, combination module 1412 combines the query counts that correspond to the respective interest categories for each subset and the selection probabilities for the respective interest categories to provide the respective category weights that are associated with the respective subset.

At step 1210, a greatest category weight that is associated with each subset is determined. In an example implementation, weight determination module 1414 determines the greatest category weight that is associated with each subset. Upon completion of step 1210, flow continues to step 1212, which is shown in FIG. 12B.

At step 1212, the greatest category weights that are associated with the respective subsets are assigned as respective session weights to the sessions that include the respective subsets. In an example implementation, weight assigning module 1416 assigns the greatest category weights that are associated with the respective subsets as the respective session weights to the sessions that include the respective subsets.

At step 1214, a recency value is assigned to each session based on an age of a most recent query instance that is included in the subset that is included in that session. The age of a query instance may be measured in any suitable units of measure, including but not limited to milliseconds, seconds, minutes, hours, days, etc. In an example implementation, recency module 1218 assigns a recency value to each session.

At step 1216, a final weight is assigned to each session based on the session weight and the recency value that are assigned to that session. For example, an aggregated monetizability value of each session and the recency value that is assigned to the respective session may be combined to generate the final weight of the respective session. In accordance with this example, the aggregated monetizability value and the recency value for each session may be combined based on historical user feedback. In an example implementation, final weight module 1420 assigns the final weight to each session.

At step 1218, a first session that includes a first subset of the query instances is selected based on the final weight that is assigned to the first session being a greatest final weight of the final weights that are assigned to the respective sessions. In an example implementation, session selection module 1406 selects the first session based on the final weight that is assigned to the first session being the greatest final weight of the final weights that are assigned to the respective sessions.

In an example embodiment, the first session may be selected in accordance with a probabilistic selection technique. In accordance with this example embodiment, a probability of selection is assigned to each session that is proportional to the final weight that is assigned to that session. For instance, if the final weight that is assigned to the first session is 80 and a final weight that is assigned to a second session is 20, session selection module 1406 may be configured to select the first session 80% of the time and to select the second session 20% of the time, instead of always selecting the session with the final weight of 80.

In some example embodiments, one or more steps 1202, 1204, 1206, 1208, 1210, 1212, 1214, 1216, and/or 1218 of flowchart 1200 may not be performed. Moreover, steps in addition to or in lieu of steps 1202, 1204, 1206, 1208, 1210, 1212, 1214, 1216, and/or 1218 may be performed.

As shown in FIG. 13, the method of flowchart 1300 begins at step 1302. In step 1302, a monetizability value is determined for each query instance that is included in a search history of a user. Each monetizability value indicates an extent to which the respective query instance is expected to generate revenue. For example, each monetizability value may be a revenue value. A revenue value indicates a revenue that is likely to be generated based on the respective query instance. In another example, each monetizability value may be a click-through probability (a.k.a. an expected click-through rate). A click-through probability indicates a likelihood of a user to select (e.g., click on) an advertisement that is provided to the user in response to the respective query instance. The search history includes sessions that correspond to respective tasks of the user. Each session includes a respective subset of the query instances that are included in the search history. In an example implementation, revenue determination module 1418 determines the monetizability value for each query instance that is included in the search history of the user.

At step 1304, the monetizability values for the query instances in each subset are aggregated to provide a respective aggregated value. For example, monetizability values for the query instances in a first subset may be aggregated to provide a first aggregated value; monetizability values for the query instances in a second subset may be aggregated to provide a second aggregated value, and so on. In an example implementation, aggregation module 1420 aggregates the monetizability values for the query instances in each subset to provide the respective aggregated value.

At step 1306, a recency value is assigned to each session based on an age of a most recent query instance that is included in the subset that is included in that session. The age of a query instance may be measured in any suitable units of measure, including but not limited to milliseconds, seconds, minutes, hours, days, etc. In an example implementation, recency module 1418 assigns a recency value to each session.

At step 1308, a final weight is assigned to each session based on the aggregated value of that session and the recency value that is assigned to that session. For instance, the aggregated value and the recency value for each session may be combined based on historical user feedback. In an example implementation, final weight module 1420 assigns the final weight to each session.

At step 1310, a first session that includes a first subset of the query instances is selected based on the final weight that is assigned to the first session being a greatest final weight of the final weights that are assigned to the respective sessions. In an example implementation, session selection module 1406 selects the first session based on the final weight that is assigned to the first session being the greatest final weight of the final weights that are assigned to the respective sessions. In an example embodiment, the first session is selected in accordance with a probabilistic selection technique.

In some example embodiments, one or more steps 1302, 1304, 1306, 1308, and/or 1310 of flowchart 1300 may not be performed. Moreover, steps in addition to or in lieu of steps 1302, 1304, 1306, 1308, and/or 1310 may be performed.

It will be recognized that ad selector 1400 may not include one or more of association module 1402, assignment module 1404, session selection module 1406, query count module 1408, selection probability module 1410, combination module 1412, weight determination module 1414, weight assigning module 1416, recency module 1418, final weight module 1420, revenue determination module 1422, and/or aggregation module 1424. Furthermore, ad selector 1400 may include modules in addition to or in lieu of association module 1402, assignment module 1404, session selection module 1406, query count module 1408, selection probability module 1410, combination module 1412, weight determination module 1414, weight assigning module 1416, recency module 1418, final weight module 1420, revenue determination module 1422, and/or aggregation module 1424.

### III. OTHER EXAMPLE EMBODIMENTS

Ad selector 110, search engine module 112, association module 402, determination module 404, instance removal module 406, segmentation module 408, assignment module 410, session selection module 412, feature extraction module 414, ad selection module 416, temporal similarity module 602, syntactic similarity module 604, semantic similarity module 606, combination module 608, session determination module 610, association module 802, segmentation module 804, time difference module 806, edit distance module 808, interest category determination module 810, session determination module 812, common word module 1102, unique word module 1104, ratio module 1106, session determination module 1108, edit distance module 1110, character module 1112, association module 1402, assignment module 1404, session selection module 1406, query count module 1408, selection probability module 1410, combination module 1412, weight determination module 1414, weight assigning module 1416, recency module 1418, final weight module 1420, revenue determination module 1422, and aggregation module 1424 may be implemented in hardware, software, firmware, or any combination thereof.

For example, ad selector 110, search engine module 112, association module 402, determination module 404, instance removal module 406, segmentation module 408, assignment module 410, session selection module 412, feature extraction module 414, ad selection module 416, temporal similarity module 602, syntactic similarity module 604, semantic similarity module 606, combination module 608, session determination module 610, association module 802, segmentation module 804, time difference module 806, edit distance module 808, interest category determination module 810, session determination module 812, common word module 1102, unique word module 1104, ratio module 1106, session determination module 1108, edit distance module 1110, character module 1112, association module 1402, assignment module 1404, session selection module 1406, query count module 1408, selection probability module 1410, combination module 1412, weight determination module 1414, weight assigning module 1416, recency module 1418, final weight module 1420, revenue determination module 1422, and/or aggregation module 1424 may be implemented as computer program code configured to be executed in one or more processors.

In another example, ad selector 110, search engine module 112, association module 402, determination module 404, instance removal module 406, segmentation module 408, assignment module 410, session selection module 412, feature extraction module 414, ad selection module 416, temporal similarity module 602, syntactic similarity module 604, semantic similarity module 606, combination module 608, session determination module 610, association module 802, segmentation module 804, time difference module 806, edit distance module 808, interest category determination module 810, session determination module 812, common word module 1102, unique word module 1104, ratio module 1106, session determination module 1108, edit distance module 1110, character module 1112, association module 1402, assignment module 1404, session selection module 1406, query count module 1408, selection probability module 1410, combination module 1412, weight determination module 1414, weight assigning module 1416, recency module 1418, final weight module 1420, revenue determination module 1422, and/or aggregation module 1424 may be implemented as hardware logic/electrical circuitry.

### IV. EXAMPLE COMPUTER IMPLEMENTATION

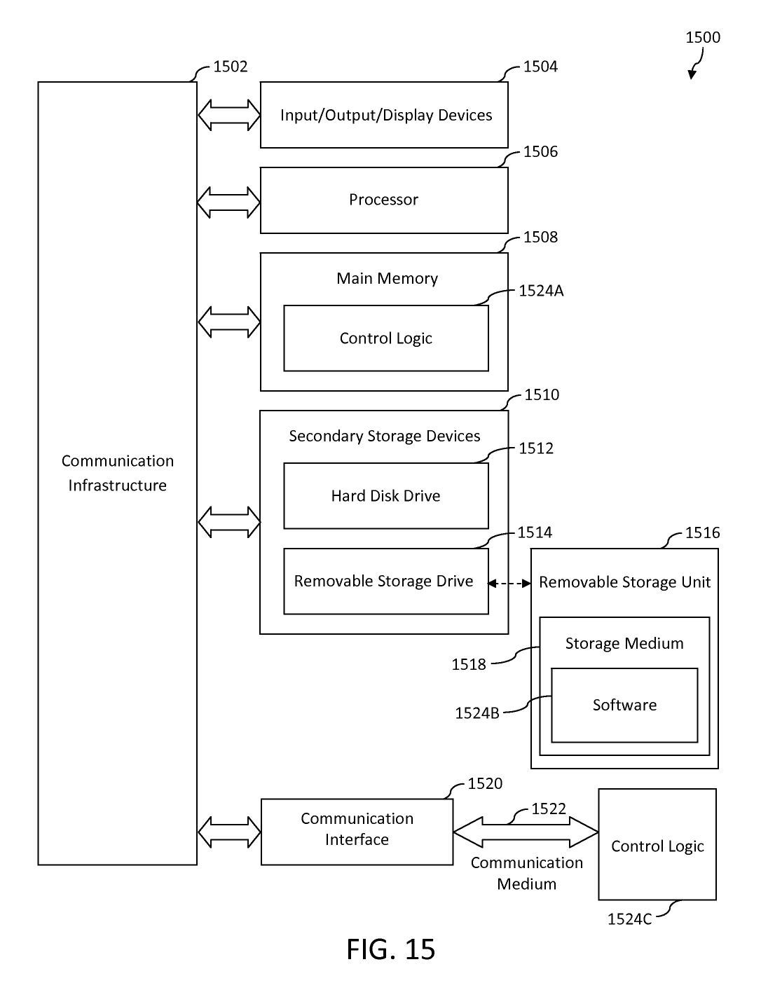

The embodiments described herein, including systems, methods/processes, and/or apparatuses, may be implemented using well known servers/computers, such as computer 1500 shown in FIG. 15. For instance, elements of example ad network 100, including any of the user systems 102A-102M, any of the publisher servers 104A-104N, advertiser system 108, and ad serving system 106 depicted in FIG. 1 and elements thereof, each of the steps of flowchart 200 depicted in FIG. 2, each of the steps of flowchart 300 depicted in FIG. 3, each of the steps of flowchart 500 depicted in FIG. 5, each of the steps of flowchart 700 depicted in FIG. 7, each of the steps of flowchart 900 depicted in FIG. 9, each of the steps of flowchart 1000 depicted in FIG. 10, each of the steps of flowchart 1200 depicted in FIGS. 12A-12B, and each of the steps of flowchart 1300 depicted in FIG. 13 can each be implemented using one or more computers 1500.

Computer 1500 can be any commercially available and well known computer capable of performing the functions described herein, such as computers available from International Business Machines, Apple, Sun, HP, Dell, Cray, etc. Computer 1500 may be any type of computer, including a desktop computer, a server, etc.

As shown in FIG. 15, computer 1500 includes one or more processors (e.g., central processing units (CPUs)), such as processor 1506. Processor 1506 may include ad selector 110 and/or search engine module 112 of FIG. 1; association module 402, determination module 404, instance removal module 406, segmentation module 408, assignment module 410, session selection module 412, feature extraction module 414, and/or ad selection module 416 of FIG. 4; temporal similarity module 602, syntactic similarity module 604, semantic similarity module 606, combination module 608, and/or session determination module 610 of FIG. 6; association module 802, segmentation module 804, time difference module 806, edit distance module 808, interest category determination module 810, and/or session determination module 812 of FIG. 8; common word module 1102, unique word module 1104, ratio module 1106, session determination module 1108, edit distance module 1110, and/or character module 1112 of FIG. 11; association module 1402, assignment module 1404, session selection module 1406, query count module 1408, selection probability module 1410, combination module 1412, weight determination module 1414, weight assigning module 1416, recency module 1418, final weight module 1420, revenue determination module 1422, and/or aggregation module 1424 of FIG. 14; or any portion or combination thereof, for example, though the scope of the embodiments is not limited in this respect. Processor 1506 is connected to a communication infrastructure 1502, such as a communication bus. In some embodiments, processor 1506 can simultaneously operate multiple computing threads.

Computer 1500 also includes a primary or main memory 1508, such as a random access memory (RAM). Main memory has stored therein control logic 1524A (computer software), and data.

Computer 1500 also includes one or more secondary storage devices 1510. Secondary storage devices 1510 include, for example, a hard disk drive 1512 and/or a removable storage device or drive 1514, as well as other types of storage devices, such as memory cards and memory sticks. For instance, computer 1500 may include an industry standard interface, such as a universal serial bus (USB) interface for interfacing with devices such as a memory stick. Removable storage drive 1514 represents a floppy disk drive, a magnetic tape drive, a compact disk drive, an optical storage device, tape backup, etc.

Removable storage drive 1514 interacts with a removable storage unit 1516. Removable storage unit 1516 includes a computer usable or readable storage medium 1518 having stored therein computer software 1524B (control logic) and/or data. Removable storage unit 1516 represents a floppy disk, magnetic tape, compact disc (CD), digital versatile disc (DVD), Blue-ray disc, optical storage disk, memory stick, memory card, or any other computer data storage device. Removable storage drive 1514 reads from and/or writes to removable storage unit 1516 in a well known manner.

Computer 1500 also includes input/output/display devices 1504, such as monitors, keyboards, pointing devices, etc.

Computer 1500 further includes a communication or network interface 1520. Communication interface 1520 enables computer 1500 to communicate with remote devices. For example, communication interface 1520 allows computer 1500 to communicate over communication networks or mediums 1522 (representing a form of a computer usable or readable medium), such as local area networks (LANs), wide area networks (WANs), the Internet, etc. Network interface 1520 may interface with remote sites or networks via wired or wireless connections. Examples of communication interface 1522 include but are not limited to a modem, a network interface card (e.g., an Ethernet card), a communication port, a Personal Computer Memory Card International Association (PCMCIA) card, etc.

Control logic 1524C may be transmitted to and from computer 1500 via the communication medium 1522.

Any apparatus or manufacture comprising a computer usable or readable medium having control logic (software) stored therein is referred to herein as a computer program product or program storage device. This includes, but is not limited to, computer 1500, main memory 1508, secondary storage devices 1510, and removable storage unit 1516. Such computer program products, having control logic stored therein that, when executed by one or more data processing devices, cause such data processing devices to operate as described herein, represent embodiments of the invention.

For example, each of the elements of example ad selector 110 and search engine module 112, each depicted in FIG. 1; association module 402, determination module 404, instance removal module 406, segmentation module 408, assignment module 410, session selection module 412, feature extraction module 414, and ad selection module 416, each depicted in FIG. 4; temporal similarity module 602, syntactic similarity module 604, semantic similarity module 606, combination module 608, and session determination module 610, each depicted in FIG. 6; association module 802, segmentation module 804, time difference module 806, edit distance module 808, interest category determination module 810, and session determination module 812, each depicted in FIG. 8; common word module 1102, unique word module 1104, ratio module 1106, session determination module 1108, edit distance module 1110, and character module 1112, each depicted in FIG. 11; association module 1402, assignment module 1404, session selection module 1406, query count module 1408, selection probability module 1410, combination module 1412, weight determination module 1414, weight assigning module 1416, recency module 1418, final weight module 1420, revenue determination module 1422, and/or aggregation module 1424, each depicted in FIG. 14; each of the steps of flowchart 200 depicted in FIG. 2; each of the steps of flowchart 300 depicted in FIG. 3; each of the steps of flowchart 500 depicted in FIG. 5; each of the steps of flowchart 700 depicted in FIG. 7; each of the steps of flowchart 900 depicted in FIG. 9; each of the steps of flowchart 1000 depicted in FIG. 10; each of the steps of flowchart 1200 depicted in FIGS. 12A-12B; and each of the steps of flowchart 1300 depicted in FIG. 13 can be implemented as control logic that may be stored on a computer usable medium or computer readable medium, which can be executed by one or more processors to operate as described herein.

### V. CONCLUSION

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
segmenting a search history of a user into a plurality of sessions that corresponds to a plurality of respective tasks of the user, the search history including a plurality of query instances, each session including a respective subset of the plurality of query instances;
assigning a plurality of weights to the plurality of respective sessions, each weight based on at least one attribute of the subset that is included in the respective session to which the weight is assigned;
selecting a first session of the plurality of sessions that includes a first subset of the plurality of query instances based on a weight that is assigned to the first session;
extracting features from query instances that are included in the first subset;
assigning weights to the respective extracted features based on at least one attribute of the first subset; and
selecting an advertisement to be provided to the user based on the extracted features and the weights that are assigned thereto.

2. The method of claim 1, wherein the plurality of query instances is associated with a plurality of respective time stamps, each time stamp specifying a time at which the query instance that is associated with that time stamp issues, the method further comprising:
removing a specified query instance from the plurality of query instances based on the specified query instance being associated with a time stamp that specifies a time that precedes a threshold time;
wherein segmenting the search history comprises:
segmenting the search history in response to removing the specified query instance from the plurality of query instances.

3. The method of claim 1, wherein the plurality of query instances is associated with a plurality of respective time stamps, each time stamp specifying a time at which the query instance that is associated with that time stamp issues; and
wherein segmenting the search history comprises:
determining a difference between a first time that is specified by a first time stamp and a second time that is specified by a second time stamp; and
determining that a first query instance that is associated with the first time stamp and a second query instance that is associated with the second time stamp are included in a common session of the search history based on the difference between the first time and the second time being less than a threshold time difference.

4. The method of claim 1, wherein segmenting the search history comprises:
determining a number of words in common between a first query instance and a second query instance;
determining a cumulative number of unique words among the first query instance and the second query instance;
determining a ratio of the number of words in common to the cumulative number of unique words; and
determining that the first query instance and the second query instance are included in a common session of the search history based on the ratio being greater than a threshold ratio.

5. The method of claim 1, wherein segmenting the search history comprises:
determining a Levenshtein edit distance between a first query instance and a second query instance;
determining a number of characters in a specified query instance, the specified query instance being the first query instance if a number of characters in the first query instance is greater than a number of characters in the second query instance, the specified query instance being the second query instance if the number of characters in the first query instance is less than or equal to the number of characters in the second query instance;
determining a ratio of the Levenshtein edit distance to the number of characters in the specified query instance; and
determining that the first query instance and the second query instance are included in a common session of the search history based on the ratio being less than a threshold ratio.

6. The method of claim 1, wherein the plurality of query instances is associated with a plurality of respective interest lists, each interest list specifying one or more interest categories of an interest taxonomy that are assigned to the query instance that is associated with that interest list; and
wherein segmenting the search history comprises:
determining that a first interest list that is associated with a first query instance and a second interest list that is associated with a second query instance include at least a threshold number of common interest categories; and
determining that the first query instance and the second query instance are included in a common session of the search history based on the first interest list and the second interest list including at least the threshold number of common interest categories.

7. The method of claim 1, wherein the plurality of query instances is associated with a plurality of respective time stamps and a plurality of respective interest lists;
wherein each time stamp specifies a time at which the query instance that is associated with that time stamp issues;
wherein each interest list specifies one or more interest categories of an interest taxonomy that are assigned to the query instance that is associated with that interest list; and
wherein segmenting the search history comprises:
determining a time difference between a first time that is specified by a first time stamp with which a first query instance is associated and a second time that is specified by a second time stamp with which a second query instance is associated,
determining an edit distance between the first query instance and the second query instance,
determining that a first interest list that is associated with the first query instance and a second interest list that is associated with the second query instance include at least a threshold number of common interest categories, and
determining that the first query instance and the second query instance are included in a common session of the search history based on the time difference being less than a threshold time difference, further based on the edit distance being less than a threshold edit distance, and further based on the first interest list and the second interest list including at least the threshold number of common interest categories.

8. The method of claim 1, wherein segmenting the search history comprises:
determining a temporal similarity regarding a first query instance and a second query instance of the plurality of query instances, the temporal similarity being a value that represents a difference between times at which the respective first and second query instances issue;
determining a syntactic similarity regarding the first and second query instances, the syntactic similarity being a value that represents a degree to which the first and second query instances have characters or words in common;
determining a semantic similarity regarding the first and second query instances, the semantic similarity being a value that represents a degree to which the first and second query instances are associated with common interest categories of an interest taxonomy;
combining the temporal similarity and a first weight to provide a weighted temporal similarity;
combining the syntactic similarity and a second weight to provide a weighted syntactic similarity;
combining the semantic similarity and a third weight to provide a weighted semantic similarity;
combining the weighted temporal similarity, the weighted syntactic similarity, and the weighted semantic similarity to provide a cumulative similarity factor; and
determining whether the first and second query instances are included in a common session of the search history based on the cumulative similarity factor.

9. The method of claim 1, wherein the plurality of query instances is associated with a plurality of respective interest lists, each interest list specifying one or more interest categories of an interest taxonomy to which the respective query instance is assigned;
wherein assigning the plurality of weights to the plurality of respective sessions comprises:
determining a number of query instances in each subset that are assigned to each interest category to provide query counts that correspond to the respective interest categories for each subset,
determining a selection probability for each interest category, each selection probability indicating a likelihood that an advertisement that is provided in response to a query instance that is assigned to the respective interest category is selected by a recipient user,
combining the query counts that correspond to the respective interest categories for each subset and the selection probabilities for the respective interest categories to provide respective category weights that are associated with the respective subset,
determining a greatest category weight that is associated with each subset,
assigning the greatest category weights that are associated with the respective subsets as respective session weights to the sessions that include the respective subsets,
assigning a recency value to each session based on an age of a most recent query instance that is included in the subset that is included in that session, and
assigning a final weight to each session of the plurality of sessions based on the session weight and the recency value that are assigned to that session; and
wherein selecting the first session comprises:
selecting the first session based on the final weight that is assigned to the first session being a greatest final weight of the final weights that are assigned to the respective sessions.

10. The method of claim 1, wherein assigning the plurality of weights to the plurality of respective sessions comprises:
determining a monetizability value for each query instance, each monetizability value indicating an extent to which the respective query instance is expected to generate revenue;
aggregating the monetizability values for the query instances in each subset to provide a respective aggregated value;
assigning a recency value to each session based on an age of a most recent query instance that is included in the subset that is included in that session; and
assigning a final weight to each session based on the aggregated value of that session and the recency value that is assigned to that session; and
wherein selecting the first session comprises:
selecting the first session based on the final weight that is assigned to the first session being a greatest final weight of the final weights that are assigned to the respective sessions.

11. The method of claim 1, further comprising:
receiving an indicator that specifies occurrence of a conversion with respect to an advertisement that is associated with a second session of the plurality of sessions; and
not selecting the second session for extraction of features in response to receiving the indicator.

12. The method of claim 1, further comprising:
receiving an indicator that specifies occurrence of a click with respect to an advertisement that is associated with the first session; and
increasing the weight that is to be assigned to the first session in response to receiving the indicator.

13. The method of claim 1, wherein the weight that is assigned to the first session is based on a term frequency that indicates a number of instances of a word or a phrase in the query instances that are included in the first subset.

14. The method of claim 1, wherein the weight that is assigned to the first session is based on an inverse document frequency that indicates a rarity of a word or a phrase that is included in a query instance that is included in the first subset.

15. The method of claim 1, wherein each weight of the plurality of weights that are assigned to the plurality of respective sessions is based on an age of a most recent query instance that is included in the subset that is included in the respective session to which the weight is assigned.

16. The method of claim 1, wherein selecting the first session comprises:
selecting the first session in accordance with a probabilistic selection technique.

17. The method of claim 1, wherein selecting the advertisement to be provided to the user comprises:
selecting the advertisement to be provided to the user further based on a context of a Web page with respect to which the advertisement is to be provided.

18. A system comprising:
a segmentation module configured to segment a search history of a user into a plurality of sessions that corresponds to a plurality of respective tasks of the user, the search history including a plurality of query instances, each session including a respective subset of the plurality of query instances;
an assignment module configured to assign a plurality of weights to the plurality of respective sessions, each weight based on at least one attribute of the subset that is included in the respective session to which the weight is assigned;
a session selection module configured to select a first session of the plurality of sessions that includes a first subset of the plurality of query instances based on a weight that is assigned to the first session;
a feature extraction module configured to extract features from query instances that are included in the first subset, the assignment module further configured to assign weights to the respective extracted features based on at least one attribute of the first subset; and
an ad selection module configured to select an advertisement to be provided to the user based on the extracted features and the weights that are assigned thereto.

19. The system of claim 18, wherein the plurality of query instances is associated with a plurality of respective time stamps, each time stamp specifying a time at which the query instance that is associated with that time stamp issues; and
wherein the segmentation module comprises:
a time difference module configured to determine a difference between a first time that is specified by a first time stamp and a second time that is specified by a second time stamp; and
a session determination module configured to determine that a first query instance that is associated with the first time stamp and a second query instance that is associated with the second time stamp are included in a common session of the search history based on the difference between the first time and the second time being less than a threshold time difference.

20. The system of claim 18, wherein the segmentation module comprises:
a common word module configured to determine a number of words in common between a first query instance and a second query instance;
a unique word module configured to determine a cumulative number of unique words among the first query instance and the second query instance;
a ratio module configured to determine a ratio of the number of words in common to the cumulative number of unique words; and
a session determination module configured to determine that the first query instance and the second query instance are included in a common session of the search history based on the ratio being greater than a threshold ratio.

21. The system of claim 18, wherein the segmentation module comprises:
an edit distance module configured to determine a Levenshtein edit distance between a first query instance and a second query instance;
a character module configured to determine a number of characters in a specified query instance, the specified query instance being the first query instance if a number of characters in the first query instance is greater than a number of characters in the second query instance, the specified query instance being the second query instance if the number of characters in the first query instance is less than or equal to the number of characters in the second query instance;
a ratio module configured to determine a ratio of the Levenshtein edit distance to the number of characters in the specified query instance; and
a session determination module configured to determine that the first query instance and the second query instance are included in a common session of the search history based on the ratio being less than a threshold ratio.

22. The system of claim 18, wherein the plurality of query instances is associated with a plurality of respective interest lists, each interest list specifying one or more interest categories of an interest taxonomy that are assigned to the query instance that is associated with that interest list; and
wherein the segmentation module comprises:
an interest category determination module configured to determine that a first interest list that is associated with a first query instance and a second interest list that is associated with a second query instance include at least a threshold number of common interest categories; and
a session determination module configured to determine that the first query instance and the second query instance are included in a common session of the search history based on the first interest list and the second interest list including at least the threshold number of common interest categories.

23. The method of claim 18, wherein the segmentation module comprises:
a temporal similarity module configured to determine a temporal similarity regarding a first query instance and a second query instance of the plurality of query instances, the temporal similarity being a value that represents a difference between times at which the respective first and second query instances issue;
a syntactic similarity module configured to determine a syntactic similarity regarding the first and second query instances, the syntactic similarity being a value that represents a degree to which the first and second query instances have characters or words in common;
a semantic similarity module configured to determine a semantic similarity regarding the first and second query instances, the semantic similarity being a value that represents a degree to which the first and second query instances are associated with common interest categories of an interest taxonomy;
a combination module configured to combine the temporal similarity and a first weight to provide a weighted temporal similarity, the combination module further configured to combine the syntactic similarity and a second weight to provide a weighted syntactic similarity, the combination module further configured to combine the semantic similarity and a third weight to provide a weighted semantic similarity, the combination module further configured to combine the weighted temporal similarity, the weighted syntactic similarity, and the weighted semantic similarity to provide a cumulative similarity factor; and
a session determination module configured to determine whether the first and second query instances are included in a common session of the search history based on the cumulative similarity factor.

24. The system of claim 18, wherein the plurality of query instances is associated with a plurality of respective interest lists, each interest list specifying one or more interest categories of an interest taxonomy to which the respective query instance is assigned;
wherein the assignment module comprises:
a query count module configured to determine a number of query instances in each subset that are assigned to each interest category to provide query counts that correspond to the respective interest categories for each subset,
a selection probability module configured to determine a selection probability for each interest category, each selection probability indicating a likelihood that an advertisement that is provided in response to a query instance that is assigned to the respective interest category is selected by a recipient user,
a combination module configured to combine the query counts that correspond to the respective interest categories for each subset and the selection probabilities for the respective interest categories to provide respective category weights that are associated with the respective subset,
a weight determination module configured to determine a greatest category weight that is associated with each subset,
a weight assigning module configured to assign the greatest category weights that are associated with the respective subsets as respective session weights to the sessions that include the respective subsets,
a recency module configured to assign a recency value to each session based on an age of a most recent query instance that is included in the subset that is included in that session, and
a final weight module configured to assign a final weight to each session of the plurality of sessions based on the session weight and the recency value that are assigned to that session; and
wherein the session selection module is configured to select the first session based on the final weight that is assigned to the first session being a greatest final weight of the final weights that are assigned to the respective sessions.

25. The system of claim 18, wherein the assignment module comprises:
a revenue determination module configured to determine a monetizability value for each query instance, each monetizability value indicating an extent to which the respective query instance is expected to generate revenue;
an aggregation module configured to aggregate the monetizability values for the query instances in each subset to provide a respective aggregated value;
a recency module configured to assign a recency value to each session based on an age of a most recent query instance that is included in the subset that is included in that session; and
a final weight module configured to assign a final weight to each session based on the aggregated value of that session and the recency value that is assigned to that session; and
wherein the session selection module is configured to select the first session based on the final weight that is assigned to the first session being a greatest final weight of the final weights that are assigned to the respective sessions.

26. The system of claim 18, wherein the session selection module is configured to not select a second session of the plurality of sessions for extraction of features in response to receipt of an indicator that specifies occurrence of a conversion with respect to an advertisement that is associated with the second session.

27. The system of claim 18, wherein the assignment module is configured to increase the weight that is to be assigned to the first session in response to receipt of an indicator that specifies occurrence of a click with respect to an advertisement that is associated with the first session.

28. The system of claim 18, wherein the ad selection module is configured to select the advertisement to be provided to the user further based on a context of a Web page with respect to which the advertisement is to be provided.

29. A computer program product comprising a computer-readable medium having computer program logic recorded thereon for enabling a processor-based system to select an advertisement, the computer program product comprising:
a first program logic module for enabling the processor-based system to segment a search history of a user into a plurality of sessions that corresponds to a plurality of respective tasks of the user, the search history including a plurality of query instances, each session including a respective subset of the plurality of query instances;
a second program logic module for enabling the processor-based system to assign a plurality of weights to the plurality of respective sessions, each weight based on at least one attribute of the subset that is included in the respective session to which the weight is assigned;
a third program logic module for enabling the processor-based system to select a first session of the plurality of sessions that includes a first subset of the plurality of query instances based on a weight that is assigned to the first session;
a fourth program logic module for enabling the processor-based system to extract features from query instances that are included in the first subset;
a fifth program logic module for enabling the processor-based system to assign weights to the respective extracted features based on at least one attribute of the first subset; and
a sixth program logic module for enabling the processor-based system to select an advertisement to be provided to the user based on the extracted features and the weights that are assigned thereto.
